(19) United States
(12) Patent Application Publication
(10) Pub. No.: US 2023/0055803 A1
(43) Pub. Date: Feb. 23, 2023

(54) HIGHLY SELECTIVE ULTRATHIN POLYMER NANOFILM COMPOSITE MEMBRANE AND PROCESS FOR PREPARATION THEREOF

(71) Applicant: COUNCIL OF SCIENTIFIC & INDUSTRIAL RESEARCH, New Delhi (IN)

(72) Inventors: Santanu KARAN, Gujarat (IN); Pulak SARKAR, Gujarat (IN); Solagna MODAK, Gujarat (IN)

(21) Appl. No.: 17/789,357

(22) PCT Filed: Dec. 26, 2020
(86) PCT No.: PCT/IN2020/051059

§ 371 Date: Jun. 27, 2022

(30) Foreign Application Priority Data
Dec. 27, 2019 (IN) 201911054162

(51) Int. Cl. B01D 69/12; B01D 67/00; B01D 69/02

(52) U.S. Cl. CPC B01D 69/125; B01D 67/0006; B01D 69/02

(57) ABSTRACT

The present invention relates to highly selective ultrathin polymer nanofilm; its composite membrane; its method of preparation. Composite membranes are produced via interfacial polymerization with addition of surface active reagents (SLS) to aqueous phase of piperazine amine and reacted with trimesoyl chloride. Fabricated ultrathin polymer nanofilm composite membrane gives high water permeance in range of 47.9-59.6 Lm⁻²h⁻¹bar⁻¹ with high rejection of Na₂SO₄ (91.77-98.47%); low rejection of MgCl₂ (3.2-10.0%); NaCl (8.9-15.3%); high water permeance in range of 8.1-16.4 Lm⁻²h⁻¹bar⁻¹ with high rejection of Na₂SO₄ (99.81-99.99%); high rejection of MgCl₂ (96.7-98.4%); NaCl (42.1-56.9%) when tested under 5 bar applied pressure at 25 (±1)° C. with 2 gL⁻¹ feed. Ideal salt selectivity for NaCl/Na₂SO₄ is in range of 296.3-4310.

### FIELD OF THE INVENTION

The present invention relates to a highly selective an ultrathin polymer nanofilm composite membrane. Particularly, present invention relates to a process for the preparation of a highly selective ultrathin polymer nanofilm composite membrane.

### BACKGROUND OF THE INVENTION

Ultrathin polymer nanofilm and its composite membrane is used for higher liquid permeance as well as to achieve higher rejection of small solutes including divalent and multivalent ions.

Nanofiltration membranes are available with molecular weight cut-off of 250 to 1000 g·mol⁻¹.

They are used for the removal of divalent and multivalent ions, small organic molecules, bacteria and viruses. They are also used in wastewater treatment, chemical product purification, food production, chlorate and chloroalkaline industry, and in the pre-treatment stages of reverse osmosis based water treatment plants.

Nanofiltration membranes are used for specific rejection of divalent ions including lead, mercury, iron, copper, magnesium, calcium, sulfate, and carbonate where the monovalent ions have negligible or moderate rejection. Generally, nanofiltration membranes produce more flux compared to the reverse osmosis membranes under a given applied pressure.

There is an enormous need for highly selective membranes for desalination to produce high quality water. The increased water permeance with compromised selectivity is not always valuable.

Sulfate ion is a common impurity in commercial salt produced from seawater and the separation process of sulfate salts from NaCl is complex.

Ion selective thin film composite membranes have been studied for over three decades and the state-of-art nanofiltration membranes are made from semi-aromatic polyamide, where the membranes are capable of separating sulfate salts from NaCl and the ideal selectivity (NaCl to Na₂SO₄) of the membranes is around 20-100.

Highly selective nanofiltration membranes are used for enhanced brine recovery and sulfate removal in chlorate and chloroalkaline industry.

In brine electrolysis processing plants, sodium chloride (300-350 g·L⁻¹ NaCl) is used as raw material to produce chlorine, sodium hydroxide and hydrogen. The purity of NaCl brine is detrimental to the product quality and up to 20 g·L⁻¹ sulfate salt impurity is the limit to avoid operational problems.

A highly selective separation process is necessary for efficient removal of sulfate salts from NaCl and for the recovery of useful materials from brine streams.

Composite nanofiltration membranes can be used for the partial or complete removal of the amount of undesirable compounds in aqueous solutions. It also relates to the significant removal of sulfate, phosphate, chromium, calcium, mercury, lead, cadmium, magnesium, aluminium and fluoride ions from brine solution.

Thin film composite (TFC) polyamide membranes are used in a variety of fluid separations including separation in organic solvents, nanofiltration (NF) and reverse osmosis (RO) desalination processes. TFC is a class of membrane where a thin film is produced or coated on a porous support which acts as a separation layer of the composite membrane. Interfacial polymerization is a technique which provides a simple route of producing composite membranes and the state-of-art NF and RO membranes are produced commercially using this technique and available worldwide. They are produced via reacting polyfunctional amine (e.g., m-phenylenediamine, piperazine) and polyfunctional acyl halide (e.g., trimesoyl chloride) reactive molecules onto the porous support from the immiscible solutions. Progress has been made to improve flux and/or rejection properties by incorporating/adding different chemicals/reagents in the reacting solutions during interfacial polymerization.

Reference may be made to U.S. Pat. No. 4,277,344A by J. E. Cadotte which describes the process of making superior reverse osmosis membranes or films or layers by condensation polymerization.

Reference may be made to U.S. Pat. No. 4,259,183A by J. E. Cadotte which describes the use of combinations of bi- and tri-functional acyl halide monomers, e.g., isophthaloyl chloride or terephthaloyl chloride with trimesoyl chloride. The produced poly(piperazineamide) NF membrane exhibits high rejection for divalent salts, particularly for magnesium sulfate, as well as produces high flux.

Reference may be made to an article J. Membr. Sci. 498, 2016, 374-384 by Y-J. Tang et al. wherein they reported the formation of piperazine based polyamide membranes by adding 2,2′-bis(1-hydroxyl-1-trifluoromethyl-2,2,2-triflutoethyl)-4,4′-methylenedianiline (BHTTM) in aqueous phase via interfacial polymerization with TMC. These membranes exhibited high pure water flux of 79.1 Lm⁻²h⁻¹ and Na₂SO₄ rejection of 99.5% with an ideal selectivity between NaCl to Na₂SO₄ of 140.

Reference may be made to an article J. Membr. Sci. 523, 2017, 282-290 by Y. Pan et al. wherein they reported the formation of poly(piperazine-amide)-based nanofiltration membrane by incorporating sericin into the active layer during interfacial polymerization between piperazine and TMC. They showed that after the incorporation of sericin (0.06% (w/v)) into the PIP-aqueous solution, the water permeability was enhanced by 36.7%, the Na₂SO₄ rejection was remained as high as 97.5% and the selectivity between NaCl to Na₂SO₄ in the mixed salt solution was increased from 21.2 to 25.2.

Reference may be made to an article Desalination 301, 2012, 75-81 by D. Hu et al. wherein they reported the formation of silica/polypiperazine-amide nanofiltration (NF) membranes by adding silica sol into the PIP-aqueous solution and reacted with TMC solution. The incorporation of silica sol increased the water flux up to 21.1% however the ideal selectivity between NaCl to Na₂SO₄ decreased from 29.7 to 10.6.

Reference may be made to an article J. Membr. Sci. 343, 2009, 219-228 by Y. Mansourpanah et al. wherein they reported the formation of composite nanofiltration membranes by adding cationic cetyltrimethylammonium bromide (CTAB), non-ionic (Triton X-100) and anionic sodium dodecyl sulfate (SDS) surfactants in organic phase during interfacial polymerization between piperazine and TMC on a UF support. The prepared membranes using SDS additive in the organic phase showed higher flux compared to the other membranes and a maximum value of the ideal selectivity between NaCl to Na₂SO₄ of 5.0 was achieved.

Reference may be made to an article Desalination 394, 2016, 176-184 by B-W. Zhou et al. wherein they reported the formation of TFC hollow fiber NF membranes via interfacial polymerization between mixed diamines of PIP and 2,2′-bis(1-hydroxyl-1-trifluoromethyl-2,2,2-triflutoethyl)-4,4′-methylenedianiline (BHTTM) in aqueous phase and TMC in organic phase. The addition of second amine (BHTTM) in the aqueous phase increased the Na₂SO₄ rejection up to a value of 99.7% and the ideal selectivity between NaCl to Na₂SO₄ up to a value of 187.

Reference may be made to an article J. Mater. Chem. A 6, 2018, 15701-15709 by J. Zhu et al. wherein they reported the synthesis of ultrathin polyamide nanofilms at a free aqueous-organic interface between aqueous solution with piperazine and n-hexane solution with trimesoyl chloride and directly transferred them onto a polydopamine coated polymer substrates via vacuum filtration which exhibited a high water permeance of 25.1 Lm⁻²h⁻¹bar⁻¹ and an excellent divalent ion rejection where the rejection of Na₂SO₄ was 99.1% with an ideal selectivity between NaCl to Na₂SO₄ of greater than 80.

Reference may be made to an article Nat. Commun. 9, 2018, 2004 by Z. Wang et al. wherein they reported the formation of polyamide film on the polydopamine decorated zirconium imidazole framework nanoparticles, which showed the high water permeance of up to 53.5 Lm⁻²h⁻¹bar⁻¹ with Na₂SO₄ rejection of 95%. The ideal selectivity between NaCl to Na₂SO₄ was 18.6.

Reference may be made to an article Science 360, 2018, 518-521 by Z. Tan et al. wherein they reported the formation of piperazine based polyamide membranes with controlled Turing structures by adding polyvinyl alcohol in aqueous phase via interfacial polymerization with TMC. These membranes gave high water permeability and high water-salt separation. The ideal between NaCl to Na₂SO₄ was 126.

Reference may be made to U.S. Pat. No. 5,152,901A by R. B. Hodgdon which discloses polyamine-polyamide composite nanofiltration membrane for water softening made on a microporous substrate by interfacial polymerization between an aqueous phase containing piperazine or polyamines and organic phase containing trimesoyl chloride or isophthaloyl chloride with a good separation of divalent and monovalent ions.

Reference may be made to U.S. Pat. No. 6,833,073B2 by A. K. Agarwal which discloses the preparation of nanofiltration and reverse osmosis membrane by using an aqueous amine solution including an amine, an organic acid (e.g., propionic acid) and a non-amine base via interfacial polymerization on a porous substrate. These membranes gave an excellent MgSO₄ rejection of up to 99.5% and flux up to 100 gallons·ft⁻²·day⁻¹.

Reference may be made to U.S. Pat. No. 4,619,767A by Y. Kamiyama et al. which describes the formation of a composite semipermeable membrane, by crosslinking polyvinyl alcohol and secondary di- or higher amines with polyfunctional crosslinking agents on a porous support for selective separation of ions. These semipermeable membranes gave an excellent water permeability and good solute rejection under low pressure.

Reference may be made to U.S. Pat. No. 3,904,519A by J. R. Mckinney et al. which discloses the preparation of reverse osmosis membranes with improved flux by crosslinking aromatic polyamide membranes using crosslinking agents and/or irradiation.

Reference may be made to CN101934201A wherein they prepared a composite nanofiltration membrane with high-selectivity by reacting polyamine and/or amine polyalcohol with chlorine polyacyl on porous support which produces a high rejection of MgSO₄ (99.56%) and NaCl (80.82%) with a water flux of 19.69 gallons·ft⁻²·day⁻¹.

Reference may be made to CN105435653A which discloses the formation of a mixed crosslinking of aromatic amine and aliphatic amine composite nanofiltration membrane on a polysulfone support with high selectivity of monovalent ion to divalent ion wherein the rejection of NaCl is less than 40%, MgCl₂ is more than 97%, MgSO₄ is more than 98% and CaCl₂ is more than 93%.

Reference may be made to CN104525000A which discloses a preparation method of a high-selective polyvinyl alcohol nanofiltration membrane with high in hydrophilicity and high in retention rate wherein the membrane gives high water flux and high separation of Na₂SO₄ and MgCl₂.

Reference may be made to U.S. Pat. No. 6,878,278B2 by W. E. Mickols which describes the addition of a wide range of complexing agents with a binding core selected from non-sulfur atoms from Groups IIIA-VIB and Periods 3-6 to the acyl halide solution to improve membrane flux and/or rejection.

Reference may be made to US20110049055A1 by H. Wang et al., which describes the preparation of composite membranes comprising moieties derived from an aromatic sulfonyl halide, a heteroaromatic sulfonyl halide, a sulfinyl halide; a sulfenyl halide; a sulfuryl halide; a phosphoryl halide; a phosphonyl halide; a phosphinyl halide; a thiophosphoryl halide; a thiophosphonyl halide, an isocyanate, a urea, a cyanate, an aromatic carbonyl halide, an epoxide or a mixture thereof to achieve improved boron selectivity.

Reference may be made to U.S. Pat. No. 6,521,130B1 by S. Kono et al., which describes the addition of carboxylic acid or carboxylic acid ester during polyamide formation to archived high water permeability while maintaining salt rejection of the membrane.

Reference may be made to U.S. Pat. Nos. 5,576,057A, 5,843,351A and 6,024,873A by S. Kono et al., which describes the process of making highly permeable composite membranes by adding at least one compound selected from the group consisting of alcohols, ethers, ketones, esters, halogenated hydrocarbons, and sulfur-containing compounds having solubility parameters of 8-14 (cal/cm³)^{1/2} to one of the coating solutions.

Reference may be made to US20090107922A1 which describes the addition of various “chain capping reagents” (e.g., 1,3 propane sultone, benzoyl chloride, 1,2-bis(bromoacetoxy) ethane) to one or both the coating solutions and various surfactants to increase water flux and decreasing salt passage.

Reference may be made to an article J. Membr. Sci. 559, 2018, 98-106 by W. Cheng et al., wherein they reported the method of making polyelectrolyte multilayer nanofiltration membranes using a layer-by-layer method by the deposition of polycation (poly(diallyldimethylammonium chloride), PDADMAC) and polyanion (poly(sodium 4-styrenesulfonate), PSS) on a commercial polyamide NF membrane. They showed that PDADMAC-terminated membrane with 5.5 bilayers exhibited 97% rejection of Mg²⁺ with selectivity between Na⁺ to Mg²⁺ of greater than 30. Reference may be made to U.S. Pat. No. 6,723,422B1 which discloses the formation of the composite reverse osmosis membrane, wherein surfactants were added in the aqueous phase to improve the absorption of the aqueous solution onto the porous support. The produced composite reverse osmosis membrane showed a high salt rejection (up to 99.5%) and a high water permeability (up to 1.0 m³m⁻²day⁻¹).

In the prior arts, ion selectivity between monovalent anion to divalent anion or monovalent cation to divalent cation is marginal and many separation applications need much higher ion selectivity to make the process feasible. There hence is a need in the art for improved membrane with much higher ion selectivity and water permeance.

As will be familiar to persons of skill in the art, interfacial polymerization is a type of three-dimensional network polymerization of two reactive molecules (monomers or polymers or a combination of them) reacting at the interface between two immiscible liquid phases (typically aqueous and organic), each containing at least one of the reactive molecule and produces a polymer thin film. In such polymerization, at least one reactive molecule has low or no solubility in the other liquid phase, which ensures a controlled introduction of one reactive molecule into an excess of reactant in the other phase. The reaction rate is typically high and can be controlled by the diffusivity of one reactive molecule from one phase to the other phase. The concentration and diffusivity of the reactive molecule in the other phase determines the chemical structure of the high molecular weight network polymers formed at the interface.

### OBJECTS OF THE INVENTION

The main object of the present invention is to provide nanofilm composite membranes with higher permeance and/or higher selectivity of monovalent anions to multivalent anions and/or monovalent cations to multivalent cations depending on the anticipated end use.

Another object of the present invention is to provide a highly selective ultrathin polymer nanofilm composite membrane and a process for preparation thereof wherein the process is most preferably adoptable for making reverse osmosis and nanofiltration membranes.

Yet another object of the present invention is to control the thickness of the polymer nanofilm made via interfacial polymerization to achieve a higher permeance.

Yet another object of the present invention is to provide nanofilm composite membranes capable of operating at low pressures (e.g., below 5 bar) and producing an acceptable permeance and/or rejection.

Yet another object of the present invention is to provide a highly selective ultrathin polymer nanofilm composite membrane via interfacial polymerization on porous support wherein the nanofilm is of the at least any of the thickness from 7-150 nm.

Yet another object of the present invention is to provides a process of isolating the ultrathin polymer nanofilm separation layer of a composite membrane.

Yet another object of the present invention is to provide a process of isolating the nanofilm separation layer of a composite membrane and to transfer the freestanding nanofilm layer onto different substrate while keeping the top surface of the nanofilm facing upward.

Yet another object of the present invention is to provide a process for the preparation of ultrathin polyamide nanofilm composite membrane by reacting piperazine (PIP) with trimesoyl chloride (TMC) via interfacial polymerization.

Yet another object of the present invention is to provide a process for the preparation of ultrathin polyamide nanofilm composite membrane by reacting PIP with TMC via interfacial polymerization and used for nanofiltration applications.

Yet another object of the present invention is to provide a process for the preparation of ultrathin polyamide nanofilm composite membrane by reacting m-phenylenediamine (MPD) with TMC via interfacial polymerization and used for reverse osmosis applications.

Yet another object of the present invention is to provide a process for the preparation of ultrathin polymer nanofilm composite membrane via interfacial polymerization and used for separation applications in non-aqueous system.

Yet another object of the present invention is to provide a process for the preparation of ultrathin polymer nanofilm composite membrane with high water permeance.

Yet another object of the present invention is to provide a process for the preparation of ultrathin polymer nanofilm composite membrane with high salt rejection.

Yet another object of the present invention is to provide a process for the preparation of ultrathin polymer nanofilm composite membrane with high ion selectivity.

Yet another object of the present invention is to provide a process for the preparation of ultrathin polymer nanofilm composite membrane with high rejection of ions from mixed salt water.

Yet another object of the present invention is to provide ultrathin polymer nanofilm composite membranes which selectively separate ions from sea water.

Yet another object of the present invention is to control the chemical structure of the polymer nanofilm to make separation membrane selective between monovalent and divalent ions.

Yet another object of the present invention is to control the interfacial reaction and hence the chemical structure of the polymer nanofilm formed at the interface by adding surface active reagent (SAR) e.g., surfactant in at least one of the molecular solution of reactive molecule.

Yet another object of the present invention is to increase the ion selectivity by adding surface active reagent (SAR) e.g., surfactant in at least one of the molecular solution of reactive molecule.

Yet another object of the present invention is to lower the organic fouling propensity.

### BRIEF DESCRIPTION OF THE DRAWINGS

FIG. 1 represents surface morphology of the nanofilm composite membranes prepared on hydrolyzed Polyacrylonitrile (HPAN) support. (A) PIP 0.05%-SAR 0 mM/TMC 0.1%-hex-5 s, (B) PIP 0.01%-SAR 0 mM/TMC 0.1%-hex-5 s, (C) PIP 1.0%-SAR 0 mM/TMC 0.1%-hex-5 s and (D) PIP 2.0%-SAR 0 mM/TMC 0.1%-hex-5 s.

FIG. 2 represents surface morphology of the nanofilm composite membranes prepared on hydrolyzed Polyacrylonitrile (HPAN) support. (A) PIP 0.05%-SLS 1 mM-hex-5 s. (B) PIP 0.1%-SLS 1 mM-hex-5 s. (C) PIP 1.0%-SLS 1 mM-hex-5 s. (D) PIP 2.0%-SLS 1 mM-hex-5 s reacted with 0.1% TMC for 5 sec.

FIG. 3 represents cross-sectional scanning electron microscope (SEM) images of the nanofilm composite membranes under different magnifications prepared on the porous alumina support. (A) PIP 0.1%-SLS 1 mM-hex-5 s, (B) PIP 0.5%-SAR 0 mM-hex-5 s and (C) PIP 2.0%-SAR 0 mM-hex-5 s.

FIG. 4 represents Atomic force microscopy (AFM) image and height profile of the freestanding nanofilm composite membranes transferred onto silicon wafers. (A and B) PIP 0.05%-SAR 0 mM/TMC 0.05%-hex-5 s and (C and D) PIP 0.05%-SAR 0 mM/TMC 0.1%-hex-5 s. (A and C) AFM height image and (B and D) corresponding height profile of the nanofilm.

FIG. 5 represents variation of water or water/methanol mixture permeance as a function of the inverse of viscosity and pure water permeance as a function of increasing temperature (K). Membranes were prepared on the cross-linked polyacrylonitrile (HPAN) supports.

FIG. 6 represents fouling behaviour, comparison of permeance decline and recovery of permeance before and after adding BSA in the feed solution. Foulant BSA (250 mgL⁻¹) was added after compaction of the membranes with pure water and further with Na₂SO₄ (2 gL⁻¹) as feed for at least 3 hours under a pressure of 5 bar at 25 (±1) ° C. and water permeances were recorded with time. After 24 hours, membranes were washed with pure water and then water permeance are collect with time by using Na₂SO₄ solution as feed at same pressure and temperature.

FIG. 7 represents variation of Na₂SO₄ rejection with feed concentration in the range from 0.5 gL⁻¹ to 40 gL⁻¹.

FIG. 8 represents variation of solute rejection with varying molecular weight of the solutes of having different charges. Three different types of molecules i.e. neutral molecules (Glucose, Sucrose, Raffinose), negative charged molecules (HNSA, Acid Orange 7, Orange G, Acid Fuchsin, Brilliant blue R) and positive charged molecules (Crysodine G, Toluidine blue O, Basic Fuchsin, Crystal Violet, Rhodamine B) were used as solute in feed solution.

FIG. 9 represents pure water flux of the nanofilm composite membranes measured with increasing pressure at 25 (±1) ° C.

FIG. 10 represents pure solvent permeance through the nanofilm composite membranes. Performance were tested under 5 bar operating pressure at 25 (±1) ° C. with a cross-flow velocity of 50 Lh⁻¹.

FIG. 11 represents acetone permeance and rejection of acid orange 7, before and after DMF activation of different nanofilm composite membranes. Performances were tested under 5 bar applied pressure at 25 (±1) ° C. with 200 mgL⁻¹ dye dissolved in acetone as feed.

FIG. 12 represents fixture assembly for clamping the PDMS rubber. Assembly was used to produce the wrinkling pattern of the freestanding nanofilm transferred onto the PDMS rubber and to calculate Young's modulus of the nanofilm. (Karan et al., Science 348, 1347, 2015).

### SUMMARY OF THE INVENTION

Accordingly, present invention relates to a highly selective ultrathin polymer nanofilm composite membrane comprising:
a) a base layer of porous polymer support membrane;
b) an upper polymer nanofilm;
wherein the polymer nanofilm is made via interfacial polymerization in presence of a surface active agent in the range of 0.01 mM to 1M; and thickness of the nanofilm is in the range of 7 nm to 150 nm.

In an embodiment of the present invention, the base layer of porous polymer support membrane is selected from the group consisting of hydrolyzed Polyacrylonitrile (HPAN), polysulfone (PSF), polyethersulfone (PES), P84, crosslinked P84 and polyacrylonitrile (PAN).

In another embodiment of the present invention, the surface active agent is selected from the group consisting of anionic, cationic, zwitterionic and neutral surfactant.

In yet another embodiment of the present invention, the pure water permeance is in the range of 8.1-57.1 Lm⁻²h⁻¹bar⁻¹, the rejection of Na₂SO₄ is greater than 98.0% to up to 99.99% and the rejection of NaCl is in between 15.3-56.9%.

In yet another embodiment of the present invention, the ideal salt selectivity of NaCl to Na₂SO₄ is greater than 1 to up to 4310.

In yet another embodiment of the present invention, the pure water permeance is in the range of 6.1-17.6 Lm⁻²h⁻¹bar⁻¹, the rejection of MgCl₂ is greater than 97.0% to up to 99.0% and the rejection of NaCl is in between 38.4-61.2%.

In yet another embodiment of the present invention, the ideal salt selectivity of NaCl to MgCl₂ is greater than 1 to up to 40.

In yet another embodiment of the present invention, the ion selectivity between monovalent anion to divalent anion in a mixed salt feed is greater than 1 to up to 1460.

In yet another embodiment of the present invention, the membrane exhibit MWCO (molecular weight cut-off) in the range of 287-390 g·mol⁻¹.

In yet another embodiment of the present invention, the nanofilm has an elemental composition of: 71.4-74.8 carbon, 7.5-12.8% nitrogen and 12.4-21.1% oxygen in case of the polymer repeating unit selected from piperazine and trimesoyl chloride.

In yet another embodiment, the present invention provides a process for the preparation of highly selective ultrathin polymer nanofilm composite membrane comprising the steps of:—
a) preparing a polymer support membrane via phase inversion method on a nonwoven fabric;
b) modifying the polymer support membrane as obtained in step (a) to obtain a hydrophilic support membrane;
c) separately dissolving 0.01 to 5.0 w/w % polyamine into an aqueous solvent to obtain a solution A;
d) separately dissolving 0.001 to 0.5 w/w % polyfunctional acid halide into an organic solvent to obtain a solution B;
e) adding 0.01 mM to 1M surface active reagent in either of the solution A or B as obtained in step (c) or step (d);
f) pouring the solution A as obtained in step (e) on the top of the hydrophilic support membrane of step (b) followed by soaking for 10 seconds to 1 minute;
g) discarding aqueous solution from the hydrophilic support membrane and removing the remaining aqueous solution with a rubber roller followed by air drying for 10 seconds to 1 minute;
h) immediately contacting solution B as obtained in step (e) to the hydrophilic support membrane of step (g) for a period in the range of 5 seconds to 20 min for interfacial polymerization to obtain a nanofilm;
i) removing excess organic solution followed by removing unreacted polyfunctional acid halide remaining on the nanofilm and drying the membrane at room temperature for 10 to 30 seconds;
j) annealing the membrane at a temperature in the range of 40 to 90° C. for a period in the range of 1 to 10 min to obtain the highly selective ultrathin polymer nanofilm composite membrane.

In yet another embodiment of the present invention, the organic solvent used in step (d) is selected from the group consisting of acyclic alkanes and isoalkanes (hexane, heptane, isopar G), monocyclic cycloalkanes (cyclohexane, cycloheptane), aromatic hydrocarbons (benzene, toluene, xylene, mesitylene), esters (methyl acetate, ethyl acetate) alone or a mixture thereof.

In yet another embodiment of the present invention, the polyamine used in step (c) is selected from the group consisting of piperazine (PIP), m-phenylenediamine (MPD), p-phenylenediamine (PPD), polyethyleneimine (PEI), 4-(Aminomethyl)piperidine (AMP), 1,3-cyclohexane diamine (CDA13), 1,4-cyclohexane diamine (CDA14), 1,6-hexanediamine (HDA), ethylene diamine (EDA), resorcinol (RES), phloroglucinol (PHL), pentaerythritol (PET), quercetin (QCT), bisphenol A (BPA), and melamine (MM) alone or in combination thereof.

In yet another embodiment of the present invention, the polyfunctional acid halide used in step (d) is selected from the group consisting of terephthaloyl chloride (TPC), 1,3,5-benzenetricarbonyl trichloride or trimesoyl chloride (TMC) alone or in combination thereof.

In yet another embodiment of the present invention, a freestanding isolated polymer nanofilm is formed at the interface when two reactive molecular solutions A and B as obtained in step (e) are contacted to form a liquid-liquid interface and further transferred onto a porous support to form a composite membrane.

In yet another embodiment of the present invention, the nanofilm, as a freestanding entity, is prepared by interfacial polymerization at the interface between two immiscible liquids and transferred onto a porous support to form a nanofilm composite membrane.

In yet another embodiment of the present invention, the nanofilm is intercalated with nanoparticle.

In yet another embodiment of the present invention, the nanofilm is arranged layer by layer on top of each other on a solid substrate.

In yet another embodiment of the present invention, the nanofilm is arranged layer by layer on top of each other on a porous support.

In yet another embodiment of the present invention, the addition of additives in either of the reactive molecular solutions during interfacial polymerization provides a nanofilm composite membrane with tuneable salt rejection properties, increased monovalent to multivalent ion selectivity and lower organic fouling.

In yet another embodiment of the present invention, the MWCO (molecular weight cut-off) is decreased to a lower value when a surfactant is added to the aqueous solution during interfacial polymerization and the observed MWCO is between 287-390 g·mol⁻¹.

### DETAILED DESCRIPTION OF THE INVENTION

The present invention is directed toward a highly selective ultrathin polymer nanofilm composite membrane and methods for making highly selective ultrathin polymer nanofilm composite membrane via interfacial polymerization (IP) on a porous support wherein the nanofilm selective layer of the membrane is of the at least any of the thickness in the range from 7-150 nm.

The present invention provides a process for the preparation of a highly selective ultrathin polymer nanofilm composite membrane via interfacial polymerization of at least two reactive molecules dissolved separately in two immiscible solvents (phases) and contacting them i) either at the interface made on a porous support or ii) at the interface between two immiscible bulk liquids.

In the case of i), an ultrafiltration porous support is soaked with a molecular solution of one reactive molecule and the excess solution is wiped-off and the support is then contacted with a molecular solution of the other reactive molecule. A nanofilm is formed on the ultrafiltration porous support.

In the case of ii), a freestanding isolated polymer nanofilm is formed at the interface when two reactive molecular solutions are contacted to form a liquid-liquid interface. The nanofilm is then transferred onto a porous support to form a composite membrane.

Porous supports are selected from the group consisting of polysulfone (PSf), polyacrylonitrile (PAN), hydrolyzed polyacrylonitrile (HPAN), polyimide (P84) and polyethersulfone (PES).

The present invention provides a process for the preparation of a highly selective ultrathin polymer nanofilm composite membrane via interfacial polymerization wherein a very amine (or polyamine)- or hydroxyl-containing reactive molecules (as a single very amine (or polyamine)- or hydroxyl-containing reactive molecule or a combination of very amine (or polyamine)- or hydroxyl-containing reactive molecules) in an aqueous phase and a polyfunctional acid halide (as a single polyfunctional acid halide molecule or a combination of polyfunctional acid halide molecules) is chosen as another reactive molecule in an organic phase.

A surface active reagent (SAR) e.g., a surfactant is used along with the at least one of the molecular solution of reactive molecule and/or adsorbed on an ultrafiltration support prior to the interfacial polymerization.

A surfactant with a concentration in the range of 0.01 mM-1M chosen from anionic, cationic, zwitterionic and neutral (non-ionic) surfactant is used along with the at least one of the molecular solution of reactive molecule and/or adsorbed on the ultrafiltration support prior to the addition of aqueous phase. Use of the surface active reagent (SAR) e.g., surfactant has role on tuning the architecture and geometry of the mold (the interface) and hence the polymer nanofilm formed at the interface of two immiscible liquids. The addition of the surfactant controls the characteristic features and morphology of the nanofilm as well as the overall charge of the polymer nanofilm and hence the degree of crosslinking.

In the present invention, the defect-free polymer nanofilm fabricated either as freestanding entity and transferred onto a porous support or directly fabricated on a porous support to form a nanofilm composite membrane shows tuneable salt rejection property.

The very amine- or hydroxyl-containing reagent is selected from the group consisting of piperazine (PIP), m-phenylenediamine (MPD), p-phenylenediamine (PPD), polyethyleneimine (PEI), 4-(Aminomethyl)piperidine (AMP), 1,3-cyclohexane diamine (CDA13), 1,4-cyclohexane diamine (CDA14), 1,6-hexanediamine (HDA), ethylene diamine (EDA), resorcinol (RES), phloroglucinol (PHL), pentaerythritol (PET), quercetin (QCT) and bisphenol A (BPA), melamine (MM) with a concentration in the range of 0.01 to 5.0 w/w %.

The polyfunctional acid halide is selected from terephthaloyl chloride (TPC) and 1,3,5-benzenetricarbonyl trichloride or trimesoyl chloride (TMC) as a reactive molecule with concentration in the range of 0.001 to 0.5 w/w %.

The polyamide nanofilm is developed onto an ultrafiltration support via interfacial polymerization reaction between piperazine (PIP) and trimesoyl chloride (TMC) by impregnating the aqueous solution containing PIP on the porous support and then reacting with the TMC solution taken in hexane, cyclohexane, heptane, toluene, octane, decane, hexadecane.

Present invention provides a process of isolating the ultrathin polymer nanofilm separation layer of a composite membrane to characterize the properties of the separation layer independent of the support. The isolated freestanding polymer nanofilm layer is transferred onto different substrates while keeping the top surface of the nanofilm facing upwards. The surface property of the nanofilm is controlled by a combination of interfacial polymerization condition and the post-annealing treatment. Solvent permeance and the ability to separate small solutes including monovalent and multivalent ions through the ultrathin polymer nanofilm composite membrane is dependent on the reactants concentration used in interfacial polymerization and the thickness of the polymer nanofilms.

Present invention further provides a process for the preparation of the polymer nanofilm composite membrane as defined herein:
a. The freestanding polymer nanofilm is arranged layer by layer on top of each other on a solid substrate to form a composite material wherein the said thin film has a thickness of less than 10 nm.
b. The freestanding polymer nanofilm is arranged layer by layer on top of each other on a porous support to form a composite membrane wherein the said thin film has a thickness of less than 10 nm.
c. The freestanding polymer nanofilm and the at least one further material are arranged as vertically stacked or in-plane heterostructure to form a composite material wherein the said thin film has a thickness of less than 10 nm.
d. The freestanding polymer nanofilms are intercalated with nanoparticles wherein the said thin film has a thickness of less than 10 nm and the size of the nanoparticles is less than 100 nm.

The nanofilm layer is selected from the group consisting of polyamide, polyurea, polyurethane, polyester, polysulfonamide, polyphtalamide, polypyrrolidine, polysiloxane, poly(amide imide), poly(ether amide), poly(ester amide) and poly(urea amide).

The present invention provides a process for the preparation of a highly selective ultrathin polymer nanofilm composite membrane via interfacial polymerization from an aqueous solution of PIP and a hexane solution of TMC wherein in presence of surface active reagent (SAR) e.g., surfactant in the aqueous solution, the produced nanofilm composite membrane gives a divalent salt rejection of 99.99%.

The present invention provides a process for the preparation of highly selective ultrathin polymer nanofilm composite membrane via interfacial polymerization from an aqueous solution of PIP and a hexane solution of TMC wherein the addition of surface active reagent (SAR) e.g., surfactant in the aqueous solution provides a composite membrane with lower organic fouling.

The present invention provides a use of the freestanding polymer nanofilm as defined herein for gas separation, insulating barrier layer thin films, transparent coating with surface active groups, polar and nonpolar thin film coating, composite materials, separation membrane in aqueous and organic solvents, water purification and desalination.

The aqueous phase reactive molecules used in the present invention may contain any of the following functional groups:
i. at least two primary aromatic amine groups (e.g., m-phenylenediamine, p-phenylenediamine, 1,3-bis(aminomethyl)benzene, m-phenylenediamine-4-methyl, 3,5-diamino-N-(4-aminophenyl) benzamide and 1,3,5-benzenetriamine).
ii. at least two primary aromatic amine groups and at least one carboxylic acid group (e.g., 3,5-diaminobenzoic acid).
iii. at least two primary aromatic amine groups and at least one methyl group (e.g., 2,4-diaminotoluene).
iv. at least two primary aromatic amine groups and at least one methoxy group (e.g., 2,4-diaminoanisole).
v. at least two primary aromatic amine groups and at least one sulfonate group (e.g., sodium 2,4-diaminobenzenesulfonate).
vi. at least two primary aliphatic amine groups (e.g., ethylenediamine, 2,2′,2″-triaminotriethylamine and polyethyleneimine).
vii. at least two primary amine groups in a cyclic or heterocyclic ring (e.g., melamine and 1,3-cyclohexanebis(methylamine)).
viii. at least two secondary amine groups in a cyclic or heterocyclic ring (e.g., piperazine).
ix. at least two aromatic hydroxyl groups (e.g., resorcinol, phloroglucinol).
x. at least one aromatic primary amine and at least one aromatic hydroxyl group (e.g., 3-aminophenol, dopamine).
xi. at least two aliphatic hydroxyl groups (e.g., N-methyl-diethanolamine).

The polyfunctional acyl halide reactive molecules in organic phase may contain at least two acyl halide groups. Preferably, acyl halide groups are aromatic in nature and contain at least two in number. Most preferably, three acyl halide groups per molecule are in an aromatic ring (e.g., trimesoyl chloride (TMC)).

As described herein, the surface active reagent (SAR) used are anionic, cationic, zwitterionic and neutral (non-ionic) surfactants and may comprise:
i. at least one anionic functional group from sulfate, alkyl-ether sulfate, sulfonate, phosphate, and carboxylates (e.g., ammonium lauryl sulfate, sodium lauryl sulfate, sodium laureth sulfate, and sodium myreth sulfate, sodium lauroyl sarcosinate, perfluorononanoic acid, perfluorooctanoic acid).
ii. at least one cationic functional group from primary amines, secondary amines, tertiary amines and quaternary ammonium salts (e.g., octenidine dihydrochloride, benzethonium chloride, cetyl-trimethyl-ammonium bromide, dimethyl-dioctadecyl-ammonium bromide, dimethyl-dioctadecyl-ammonium chloride, cetylpyridinium chloride, benzalkonium chloride)
iii. at least one cationic functional group from primary amines, secondary amines, tertiary amines and quaternary ammonium salts and at least one anionic functional group from sulfate, alkyl-ether sulfate, sulfonate, phosphate, and carboxylates (e.g., 3-[(3-cholamidopropyl) dimethylammonio]-1-propanesulfonate, dodecylphosphocholine (DPC), 3-(dodecyldimethylammonio) propanesulfonate (DPS), 2-[(3-dodecanamidopropyl)dimethylaminio]acetate, N,N-dimethyl-N-(3-cocamidopropyl)-3-ammonio-2-hydroxypropylsulfonate, phosphatidylserine, 1-oleoyl-2-palmitoyl-phosphatidylcholine, sphingomyelin)
iv. a non-ionic block copolymer chain composed of a central hydrophobic block of poly(propylene glycol) or amine connected by two hydrophilic blocks of poly(ethylene glycol) wherein each block may contain 2-100 units of hydrophilic polyether units (e.g., polyoxyethyleneamine, Poly(ethylene glycol)-block-poly(propylene glycol)-block-poly(ethylene glycol), Pluronic© F-127, Polyethylene glycol (15)-hydroxystearate, Polyoxyethylene (20) sorbitan monolaurate).
v. at least one polymer chain comprising hydrophilic polyether chain containing 2-100 units and a hydrophobic aromatic hydrocarbon group (e.g., polyethylene glycol p-(1,1,3,3-tetramethylbutyl)-phenyl ether (Triton X-100), 4-nonylphenyl-polyethylene glycol).
vi. at least one polymer chain containing organosilane, organosiloxane group or dendrimer and a hydrophilic polyether chain containing 2-100 units.

The term “ultrathin polymer nanofilm composite membrane” used herein refers to the composite membrane as a product wherein the polymer separation layer is of the at least any of the thickness from 1-200 nm and fabricated via interfacial polymerization i) either at the interface made on a porous support or ii) at the interface between two bulk liquids and transferred onto the porous support.

The ultrathin polymer layer is polyamide with varying thickness from 7 nm to 150 nm.

The highly selective ultrathin polymer nanofilm of the nanofilm composite membrane has a thickness of less than 50 nm (e.g., 1-40 nm). Suitably, the highly selective ultrathin polymer nanofilm of the nanofilm composite membrane has a thickness of less than 20 nm. More suitably, the highly selective ultrathin polymer nanofilm of the nanofilm composite membrane has a thickness of less than 15 nm (for example, less than 10 nm or less than 8 nm). The ultrathin polymer nanofilm has a thickness of less than 10 nm (e.g., 1-10 nm). More suitably, ultrathin polymer nanofilm has a thickness of less than 8 nm (for example, 7 nm).

The elemental composition (atomic %) of the nanofilms are as follows: 71.4 to 73.5% carbon, 7.5 to 10.6% nitrogen and 15.9 to 21.1% oxygen.

The elemental composition (atomic %) of the nanofilms are as follows: 73.8 to 74.2% carbon, 7.9 to 9.2% nitrogen and 16.6 to 18.2% oxygen.

The elemental composition (atomic %) of the nanofilms are as follows: 72.6 to 74.8% carbon, 11.1 to 12.8% nitrogen and 12.4 to 16.3% oxygen.

The elemental composition (atomic %) of the nanofilm is as follows: 73.6±0.9% carbon, 10.9±0.8% nitrogen and 15.5±0.4% oxygen.

When the nanofilm comprises nitrogen and oxygen-containing moieties, it will be understood that such moieties form an integral part of the nanofilm's structure, rather than being mere surface contamination.

The ultrathin polymer nanofilm composite membrane has a water contact angle value of 25.7-59.6°. Suitably, the ultrathin polymer nanofilm composite membrane has a water contact angle value of 25.7-56.9°. More suitably, the ultrathin polymer nanofilm composite membrane has a water contact angle value of 25.7-45.2°. Most suitably, the ultrathin polymer nanofilm composite membrane has a water contact angle value of 32.2-47.5°.

The ultrathin polymer nanofilm composite membrane has a zeta potential value of −12.2 to −23.4 mV measured at pH 7.0. Suitably, the ultrathin polymer nanofilm composite membrane has a zeta potential value of −12.2 to −27.2 mV measured at pH 7.0. Most suitably, the ultrathin polymer nanofilm composite membrane has a zeta potential value of −18.8 to −26.0 mV measured at pH 7.0.

The highly selective ultrathin polymer nanofilm composite membrane is fabricated via interfacial polymerization of low concentration of aqueous solution of PIP (0.01-0.05 w/w %) with the addition of surface active reagent (SAR) e.g., surfactant and hexane solution of TMC, wherein the fabricated ultrathin polymer nanofilm composite membrane on HPAN support gives a high water (pure) permeance in the range of 16.9-59.0 Lm⁻²h⁻¹bar⁻¹ with high rejection of Na₂SO₄ (91.43-99.95%) by maintaining a rejection of MgCl₂ (2.7-94.6%) and NaCl (9.7-45.0%) when tested under 5 bar applied pressure at 25 (±1) ° C. with a 2 gL⁻¹ feed solution. An ideal salt selectivity for NaCl/Na₂SO₄ in the range of 9.5-1198 is achieved.

The highly selective ultrathin polymer nanofilm composite membrane is fabricated via interfacial polymerization of moderate concentration of aqueous solution of PIP (0.1 w/w %) with the addition of a surface active reagent (SAR) e.g., surfactant and a hexane solution of TMC, wherein the fabricated ultrathin polymer nanofilm composite membrane on HPAN support gives a high water (pure) permeance in the range of 8.1-16.4 Lm⁻²h⁻¹bar⁻¹ with high rejection of Na₂SO₄ (99.81-99.99%) by maintaining high rejection of MgCl₂ (96.7-98.4%) and NaCl (42.1-56.9%) when tested under 5 bar applied pressure at 25 (±1) ° C. with a 2 gL⁻¹ feed solution. An ideal salt selectivity for NaCl/Na₂SO₄ in the range of 296.3-4310 is achieved.

The highly selective ultrathin polymer nanofilm composite membrane is fabricated via interfacial polymerization of moderate concentration of aqueous solution of PIP (1 w/w %) with the addition of surface active reagent (SAR) e.g., surfactant and hexane solution of TMC, wherein the fabricated ultrathin polymer nanofilm composite membrane on HPAN support gives a high water (pure) permeance in the range of 6.1-13.7 Lm⁻²h⁻¹bar⁻¹ with high rejection of Na₂SO₄ (32.55-91.73%) by maintaining high rejection of MgCl₂ (89.5-99.0%) and NaCl (30.7-61.2%) when tested under 5 bar applied pressure at 25 (±1) ° C. with a 2 gL⁻¹ feed solution. An ideal salt selectivity of 4.7 for NaCl/Na₂SO₄ is achieved.

The highly selective ultrathin polymer nanofilm composite membrane is fabricated via interfacial polymerization of high concentration of aqueous solution of PIP (2 w/w %) with the addition of surface active reagent (SAR) e.g., surfactant and hexane solution of TMC, wherein the fabricated ultrathin polymer nanofilm composite membrane on HPAN support gives a water (pure) permeance of 4.4 Lm⁻²h⁻¹bar⁻¹ with low rejection of Na₂SO₄ (39.93%) by maintaining high rejection of MgCl₂ (98.4%) and NaCl (54.5%) when tested under 5 bar applied pressure at 25 (±1) ° C. with a 2 gL⁻¹ feed solution. An ideal salt selectivity of 28.4 for NaCl/MgCl₂ is achieved.

The highly selective ultrathin polymer nanofilm composite membrane is fabricated via interfacial polymerization of different concentration of aqueous solution of PIP (0.05-0.1 w/w %) with the addition of surface active reagent (SAR) e.g., surfactant and hexane solution of TMC, wherein the fabricated ultrathin polymer nanofilm composite membrane on HPAN support gives an ideal salt selectivity for NaCl/MgCl₂ in the range of 2.2-35.3.

The highly selective ultrathin polymer nanofilm composite membrane is fabricated via interfacial polymerization at high concentration of aqueous solution of PIP (1-2 w/w %) with the addition of surface active reagent (SAR) e.g., surfactant and hexane solution of TMC, wherein the fabricated ultrathin polymer nanofilm composite membrane on HPAN support gives an ideal salt selectivity for NaCl/MgCl₂ in the range of 6.6-38.8.

The highly selective ultrathin polymer nanofilm composite membrane is fabricated via interfacial polymerization of low concentration of aqueous solution of PIP (0.1 w/w %) with the addition of surface active reagent (SAR) e.g., surfactant and hexane solution of TMC, wherein the fabricated ultrathin polymer nanofilm composite membrane on PAN, P84 and PES supports give a high water (pure) permeance in the range of 14.1-45.6 Lm⁻²h⁻¹bar⁻¹ with high rejection of Na₂SO₄ (90.65-99.70%) by maintaining high rejection of MgCl₂ (5.8-93.1%) and NaCl (11.3-42.8%) when tested under 5 bar applied pressure at 25 (±1) ° C. with a 2 gL⁻¹ feed solution. An ideal salt selectivity for NaCl/Na₂SO₄ in the range of 9.5-190.7 is achieved.

The highly selective ultrathin polymer nanofilm composite membrane is fabricated via interfacial polymerization of low concentration of aqueous solution of PIP (0.1 w/w %) with the addition of surface active reagent (SAR) e.g., surfactant and organic solution of TMC, wherein the fabricated ultrathin polymer nanofilm composite membrane on HPAN support and the organic phase solvent is chosen from heptane, toluene and cyclohexane gives a high water (pure) permeance in the range of 13.3-15.3 Lm⁻²h⁻¹bar⁻¹ with high rejection of Na₂SO₄ (57.15-99.79%) by maintaining high rejection of MgCl₂ (89.4-97.7%) and NaCl (30.9-43.8%) when tested under 5 bar applied pressure at 25 (±1) ° C. with a 2 gL⁻¹ feed solution. An ideal salt selectivity for NaCl/Na₂SO₄ is in the range of 1.6-267.6 and an ideal salt selectivity for NaCl/MgCl₂ in the range of 6.5-25.4 is achieved.

The highly selective ultrathin polymer nanofilm composite membrane is fabricated via interfacial polymerization of moderate concentration of aqueous solution of PIP (0.1 w/w %) with the addition of a surface active reagent (SAR) e.g., surfactant and a hexane solution of TMC, wherein the fabricated ultrathin polymer nanofilm composite membrane on HPAN support gives a high water (pure) permeance in the range of 12.9-16.4 Lm⁻²h⁻¹bar⁻¹ with high rejection of SO₄²⁻ (99.78-99.95%) and low rejection of Cl⁻ (−4.8-39.1%) when tested under 5-20 bar applied pressure at 25 (±1) ° C. with a 2-40 gL⁻¹ feed mixed salt (Na₂SO₄+NaCl; equally weighted) solution. Ion selectivity in the mixed salts for Cl⁻/SO₄²⁻ in the range of 476-1460 is achieved.

The highly selective ultrathin polymer nanofilm composite membrane is fabricated via interfacial polymerization of moderate concentration of aqueous solution of PIP (0.1 w/w %) with the addition of a surface active reagent (SAR) e.g., surfactant and a hexane solution of TMC, wherein the fabricated ultrathin polymer nanofilm composite membrane on HPAN support gives a high water (pure) permeance in the range of 12.9-16.4 Lm⁻²h⁻¹bar⁻¹ with high rejection of SO₄²⁻ (99.89-99.94%) and low rejection of Cl⁻ (30.0-48.5%) when tested under 5-20 bar applied pressure at 25 (±1) ° C. with a 2-40 gL⁻¹ feed mixed salt (Na₂SO₄+MgSO₄+MgCl₂+NaCl; equally weighted) solution. Ion selectivity in the mixed salts for Cl⁻/SO₄²⁻ in the range of 636.4-1045 is achieved.

The highly selective ultrathin polymer nanofilm and its composite membrane showed a MWCO in between 287-390 g·mol⁻¹ and a decrease in MWCO was observed when surface active reagent (SAR) e.g., surfactant was added to the aqueous solution during interfacial polymerization.

The highly selective ultrathin polymer nanofilm composite membrane of the present invention offers a wealth of advantages over similar membranes that are known in the art. The composite membranes of the present invention have enhanced ion selectivity when compared with the currently available membranes. By executing the process defined herein the highly selective ultrathin polymer nanofilm composite membranes of the present invention having a thickness of less than 10 nm with an ideal selectivity between NaCl to Na₂SO₄ greater than 50 to up to 4310 can reliably be prepared. Moreover, the composition of the nanofilms offers advantages in the fields of separation/filtration technologies, organic synthesis coupled with membrane separation processes, catalyst recovery and in pharmaceutical industries.

### EXAMPLES

Following examples are given by way of illustration and therefore should not be construed to limit the scope of the invention.

### Example 1

Preparation of Ultrafiltration Support Membranes and Crosslinking of the Support Membranes

Ultrafiltration polysulfone (PSf), polyethersulfone (PES), P84 and polyacrylonitrile (PAN) support membranes were prepared via phase inversion method. Polyacrylonitrile (PAN) support membranes were prepared on a nonwoven fabric by using a continuous casting machine. First PAN polymer powder was dried in a hot air oven at 70 (±1) ° C. for two hours and then dried PAN was dissolved in DMF by continuous stirring at 70 (±1) ° C. for several hours in an airtight glass flask to make a 13.0 w/w % polymer solution. Polymer solution was then allowed to cool down to room temperature, 25 (±1) ° C. Membrane sheet of 60 m length and 0.32 m wide was continuously cast on a nonwoven fabric by maintaining a gap (130-150 μm) between the casting knife and the nonwoven fabric at a speed of 4-7 m/min using a semi-continuous casting machine. During this process, polymer film along with the nonwoven fabric is taken into water gelation bath maintained at 25 (±1) ° C. and allowed phase inversion to form ultrafiltration membrane and finally taken in a winder roller. The distance between the knife position and the water gelation bath i.e. the distance traveled in air was 0.35 m. Membrane roll was washed with pure water by re-rolling on an another winder roller and cut into pieces of dimension 16 cm×27 cm and kept in pure water for two days prior to the final storage at 10 (±1) ° C. in isopropanol and water mixture (1:1 v/v). For crosslinking of ultrafiltration supports, several pieces (75 nos.) of PAN supports were taken out from the storage solution and washed thoroughly in pure water. Supports were then immersed in a 5 L of 1 M sodium hydroxide (NaOH) solution preheated at 60 (±1) ° C. for 2 h and the solution was again placed in a hot air oven at 60 (±1) ° C. for 2 h to allow hydrolysis. After crosslinking, PAN membranes were washed with pure water and stored in pure water for several days. The pH of water was regularly checked and exchanged with pure water every day until the pH was reached to 7. Finally, the hydrolyzed PAN (HPAN) membrane pieces were stored at 10 (±1) ° C. in isopropanol and water mixture (1:1 v/v). Similarly, PSf polymer solution was prepared by dissolving 17 w/w % of PSf in NMP, P84 polymer solution was prepared by dissolving 22 w/w % of P84 in DMF and PES polymer solution was prepared by dissolving 19 w/w % of PES along with 3 w/w % of PVP in DMF. Support membranes were fabricated via phase inversion method as discussed above.

### Example 2

Preparation of Nanofilm Composite Membranes in the Presence of Surface Active Reagent [SAR]

Nanofilm composite membranes were prepared via interfacial polymerization technique on top of HPAN, PAN, PSf, PES, P84 support membranes. Support membrane was washed with ultrapure water to remove excess isopropanol, where it was stored. Then the aqueous solution containing a reactive molecule chosen from PIP, MPD, PPD, AMP, PEI, CDA13, CDA14, HDA, EDA, RES, PHL, PET, QCT, BPA, MM with a concentration in the range of 0.01 to 5.0 w/w % was poured on top of the support and soaked for 20 s. After that, excess aqueous solution was removed from the support with a rubber roller and gently air dried for 10 s. Immediately organic solution containing TMC with a concentration in the range of 0.001 to 0.5 w/w % was put in contact of the support for a designated time (5 s to 20 min) to happen the interfacial polymerization reaction. The organic solvents used for interfacial polymerization were selected from acyclic alkanes and isoalkanes (e.g., hexane, heptane, isopar G), monocyclic cycloalkanes (e.g., cyclohexane, cycloheptane), aromatic hydrocarbons (e.g., benzene, toluene, xylene, mesitylene), esters (e.g., methyl acetate, ethyl acetate) and/or their mixture thereof. The room temperature and relative humidity was maintained at 23-25° C. and 25-35%, respectively during the interfacial polymerization. Excess organic solution containing TMC was removed soon after the interfacial polymerization reaction and dried at room temperature for 10-30 s and finally annealed at a specified temperature of 40-90° C. for a specified time of 1-10 min in a hot air oven. Unless otherwise mentioned, the organic solvent used for interfacial polymerization i.e. the TMC solution was made in hexane, the drying time at room temperature after the interfacial polymerization was 10 s and the annealing temperature was 70 (±1°) C for 1 min.

Surface active reagent (SAR) e.g., surfactant added in the i) aqueous phase, ii) organic phase and iii) aqueous and organic phases containing the reactive molecules. The concentration of surfactants was in the range of 0.01 mM-1 M. Unless otherwise stated, the additive was used in the aqueous phase, TMC was taken in hexane solution for the interfacial polymerization, the drying time at room temperature after the interfacial polymerization was 10 s and the annealing temperature was 70 (±1) ° C. for 1 min. Preparation conditions are summarized in Table 1.

TABLE 1
Preparation conditions of polymer nanofilm composite membranes via interfacial polymerization
Post treatment was done by annealing the nanofilm composite membrane at 70 (±1) ° C. for 1 minute in a hot air oven.
Table 1

| | | Reactive | | | | | | | |
|---|---|---|---|---|---|---|---|---|---|
| | | molecule in | | SAR in | | | | | |
| Polymer nanofilms | | aqueous | | aqueous | | | | IP time | |
| (aqueous phase wt %-surface active reagent | UF | phase | | phase | | TMC in organic | | (sec or | |
| (SAR)/TMC wt % in organic phase-IP time) | support | [wt %] | | [mM] | | phase [wt %] | | min) | |
| PIP 0.05%-SAR 0 mM/TMC 0.05%-hex-5 s | HPAN | PIP | [0.05] | 0.0 | | TMC/hexane | [0.05] | 5 | sec |
| PIP 0.05%-SAR 0 mM/TMC 0.1%-hex-5 s | HPAN | PIP | [0.05] | 0.0 | | TMC/hexane | [0.1] | 5 | sec |
| PIP 0.05%-SAR 0 mM/TMC 0.15%-hex-5 s | HPAN | PIP | [0.05] | 0.0 | | TMC/hexane | [0.15] | 5 | sec |
| PIP 0.1%-SAR 0 mM/TMC 0.05%-hex-5 s | HPAN | PIP | [0.1] | 0.0 | | TMC/hexane | [0.05] | 5 | sec |
| PIP 0.1%-SAR 0 mM/TMC 0.1%-hex-5 s | HPAN | PIP | [0.1] | 0.0 | | TMC/hexane | [0.1] | 5 | sec |
| PIP 0.1%-SAR 0 mM/TMC 0.15%-hex-5 s | HPAN | PIP | [0.1] | 0.0 | | TMC/hexane | [0.15] | 5 | sec |
| PIP 1.0%-SAR 0 mM/TMC 0.05%-hex-5 s | HPAN | PIP | [1.0] | 0.0 | | TMC/hexane | [0.05] | 5 | sec |
| PIP 1.0%-SAR 0 mM/TMC 0.1%-hex-5 s | HPAN | PIP | [1.0] | 0.0 | | TMC/hexane | [0.1] | 5 | sec |
| PIP 1.0%-SAR 0 mM/TMC 0.15%-hex-5 s | HPAN | PIP | [1.0] | 0.0 | | TMC/hexane | [0.15] | 5 | sec |
| PIP 2.0%-SAR 0 mM/TMC 0.05%-hex-5 s | HPAN | PIP | [2.0] | 0.0 | | TMC/hexane | [0.05] | 5 | sec |
| PIP 2.0%-SAR 0 mM/TMC 0.1%-hex-5 s | HPAN | PIP | [2.0] | 0.0 | | TMC/hexane | [0.1] | 5 | sec |
| PIP 2.0%-SAR 0 mM/TMC 0.15%-hex-5 s | HPAN | PIP | [2.0] | 0.0 | | TMC/hexane | [0.15] | 5 | sec |
| PIP 0.01%-SLS 1 mM/TMC 0.1%-hex-5 s | HPAN | PIP | [0.01] | SLS | [1.0] | TMC/hexane | [0.1] | 5 | sec |
| PIP 0.01%-SLS 1 mM/TMC 0.15%-hex-5 s | HPAN | PIP | [0.01] | SLS | [1.0] | TMC/hexane | [0.15] | 5 | sec |
| PIP 0.05%-SLS 1 mM/TMC 0.05%-hex-5 s | HPAN | PIP | [0.05] | SLS | [1.0] | TMC/hexane | [0.05] | 5 | sec |
| PIP 0.05%-SLS 0.5 mM/TMC 0.1%-hex-5 s | HPAN | PIP | [0.05] | SLS | [0.5] | TMC/hexane | [0.1] | 5 | sec |
| PIP 0.05%-SLS 1 mM/TMC 0.1%-hex-5 s | HPAN | PIP | [0.05] | SLS | [1.0] | TMC/hexane | [0.1] | 5 | sec |
| PIP 0.05%-SLS 2 mM/TMC 0.1%-hex-5 s | HPAN | PIP | [0.05] | SLS | [2.0] | TMC/hexane | [0.1] | 5 | sec |
| PIP 0.05%-SLS 5 mM/TMC 0.1%-hex-5 s | HPAN | PIP | [0.05] | SLS | [5.0] | TMC/hexane | [0.1] | 5 | sec |
| PIP 0.05%-SLS 10 mM/TMC 0.1%-hex-5 s | HPAN | PIP | [0.05] | SLS | [10.0] | TMC/hexane | [0.1] | 5 | sec |
| PIP 0.05%-SLS 1 mM/TMC 0.15%-hex-5 s | HPAN | PIP | [0.05] | SLS | [1.0] | TMC/hexane | [0.15] | 5 | sec |
| PIP 0.1%-SLS 1 mM/TMC 0.05%-hex-5 s | HPAN | PIP | [0.1] | SLS | [1.0] | TMC/hexane | [0.05] | 5 | sec |
| PIP 0.1%-SLS 1 mM/TMC 0.1%-hex-5 s | HPAN | PIP | [0.1] | SLS | [1.0] | TMC/hexane | [0.1] | 5 | sec |
| PIP 0.1%-SLS 1 mM/TMC 0.1%-hex-30 s | HPAN | PIP | [0.1] | SLS | [1.0] | TMC/hexane | [0.1] | 30 | sec |
| PIP 0.1%-SLS 1 mM/TMC 0.1%-hex-2 min | HPAN | PIP | [0.1] | SLS | [1.0] | TMC/hexane | [0.1] | 2 | min |
| PIP 0.1%-SLS 1 mM/TMC 0.1%-hex-20 min | HPAN | PIP | [0.1] | SLS | [1.0] | TMC/hexane | [0.1] | 20 | min |
| PIP 0.1%-SLS 1 mM/TMC 0.1%-hex-5 s-PAN | PAN | PIP | [0.1] | SLS | [1.0] | TMC/hexane | [0.1] | 5 | sec |
| PIP 0.1%-SLS 1 mM/TMC 0.1%-hex-5 s-P84 | P84 | PIP | [0.1] | SLS | [1.0] | TMC/hexane | [0.1] | 5 | sec |
| PIP 0.1%-SLS 1 mM/TMC 0.1%-hex-5 s-PSf | PSf | PIP | [0.1] | SLS | [1.0] | TMC/hexane | [0.1] | 5 | sec |
| PIP 0.1%-SLS 1 mM/TMC 0.1%-hex-5 s-PES | PES | PIP | [0.1] | SLS | [1.0] | TMC/hexane | [0.1] | 5 | sec |
| PIP 0.1%-SLS 1 mM/TMC 0.1%-hep-5 s | HPAN | PIP | [0.1] | SLS | [1.0] | TMC/heptane | [0.1] | 5 | sec |
| PIP 0.1%-SLS 1 mM/TMC 0.1%-tol-5 s | HPAN | PIP | [0.1] | SLS | [1.0] | TMC/toluene | [0.1] | 5 | sec |
| PIP 0.1%-SLS 1 mM/TMC 0.1%-clh-5 s | HPAN | PIP | [0.1] | SLS | [1.0] | TMC/cyclohexane | [0.1] | 5 | sec |
| PIP 0.1%-SLS 1 mM/TMC 0.15%-hex-5 s | HPAN | PIP | [0.1] | SLS | [1.0] | TMC/hexane | [0.15] | 5 | sec |
| PIP 1.0%-SLS 1 mM/TMC 0.05%-hex-5 s | HPAN | PIP | [1.0] | SLS | [1.0] | TMC/hexane | [0.05] | 5 | sec |
| PIP 1.0%-SLS 1 mM/TMC 0.1%-hex-5 s | HPAN | PIP | [1.0] | SLS | [1.0] | TMC/hexane | [0.1] | 5 | sec |
| PIP 1.0%-SLS 1 mM/TMC 0.15%-hex-5 s | HPAN | PIP | [1.0] | SLS | [1.0] | TMC/hexane | [0.15] | 5 | sec |
| PIP 2.0%-SLS 1 mM/TMC 0.05%-hex-5 s | HPAN | PIP | [2.0] | SLS | [1.0] | TMC/hexane | [0.05] | 5 | sec |
| PIP 2.0%-SLS 1 mM/TMC 0.1%-hex-5 s | HPAN | PIP | [2.0] | SLS | [1.0] | TMC/hexane | [0.1] | 5 | sec |
| PIP 2.0%-SLS 1 mM/TMC 0.15%-hex-5 s | HPAN | PIP | [2.0] | SLS | [1.0] | TMC/hexane | [0.15] | 5 | sec |
| PEI 0.05%-SAR 0 mM/TMC 0.05%-hex-5 s | HPAN | PEI | [0.05] | 0.0 | | TMC/hexane | [0.05] | 5 | sec |
| PEI 0.05%-SLS 1 mM/TMC 0.05%-hex-5 s-pH | HPAN | PEI | [0.05] | SLS | [1.0] | TMC/hexane | [0.05] | 5 | sec |
| 10.2* | | | | | | | | | |
| PIP 0.1%-CTAB 1 mM/TMC 0.1%-hex-5 s | HPAN | PIP | [0.1] | CTAB | [0.5] | TMC/hexane | [0.1] | 5 | sec |
| PIP 0.1%-CTAB 1 mM/TMC 0.1%-hex-5 s | HPAN | PIP | [0.1] | CTAB | [1.0] | TMC/hexane | [0.1] | 5 | sec |
| PIP 0.1%-X-100 1 mM/TMC 0.1%-hex-5 s | HPAN | PIP | [0.1] | X-100 | [0.5] | TMC/hexane | [0.1] | 5 | sec |
| PIP 0.1%-X-100 1 mM/TMC 0.1%-hex-5 s | HPAN | PIP | [0.1] | X-100 | [1.0] | TMC/hexane | [0.1] | 5 | sec |
| MPD 0.1%-SLS 1 mM/TMC 0.1%-hex-5 s | HPAN | MPD | [0.1] | SLS | [1.0] | TMC/hexane | [0.1] | 5 | sec |
| PPD 0.1%-SLS 1 mM/TMC 0.1%-hex-5 s | HPAN | PPD | [0.1] | SLS | [1.0] | TMC/hexane | [0.1] | 5 | sec |
| AMP 0.1%-SLS 1 mM/TMC 0.1%-hex-5 s | HPAN | AMP | [0.1] | SLS | [1.0] | TMC/hexane | [0.1] | 5 | sec |
| CDA13-0.1%-SLS 1 mM/TMC 0.1%-hex-5 s | HPAN | CDA | [0.1] | SLS | [1.0] | TMC/hexane | [0.1] | 5 | sec |
| CDA14 0.1%-SLS 1 mM/TMC 0.1%-hex-5 s | HPAN | CDA | [0.1] | SLS | [1.0] | TMC/hexane | [0.1] | 5 | sec |
| HDA 0.1%-SLS 1 mM/TMC 0.1%-hex-5 s | HPAN | HDA | [0.1] | SLS | [1.0] | TMC/hexane | [0.1] | 5 | sec |
| EDA 0.1%-SLS 1 mM/TMC 0.1%-hex-5 s | HPAN | EDA | [0.1] | SLS | [1.0] | TMC/hexane | [0.1] | 5 | sec |
| RES 0.1%-SLS 1 mM/TMC 0.1%-hex-5 s-pH 12.0* | HPAN | RES | [0.1] | SLS | [1.0] | TMC/hexane | [0.1] | 5 | sec |
| PHL 0.1%-SLS 1 mM/TMC 0.1%-hex-5 s-pH 12.0* | HPAN | PHL | [0.1] | SLS | [1.0] | TMC/hexane | [0.1] | 5 | sec |
| PET 0.1%-SLS 1 mM/TMC 0.1%-hex-5 s-pH 13.0* | HPAN | PET | [0.1] | SLS | [1.0] | TMC/hexane | [0.1] | 5 | sec |
| QCT 0.1%-SLS 1 mM/TMC 0.1%-hex-5 s-pH 12.0* | HPAN | QCT | [0.1] | SLS | [1.0] | TMC/hexane | [0.1] | 5 | sec |
| BPA 0.1%-SLS 1 mM/TMC 0.1%-hex-5 s-pH 11.0* | HPAN | BPA | [0.1] | SLS | [1.0] | TMC/hexane | [0.1] | 5 | sec |
| MM 0.1%-SLS 1 mM/TMC 0.1%-hex-5 s | HPAN | MM | [0.1] | SLS | [1.0] | TMC/hexane | [0.1] | 5 | sec |
| PIP 0.1%/TMC 0.1%-SLS 1 mM-hex-5 s | HPAN | PIP | [0.1] | SLS | [1.0] | TMC/hexane | [0.1] | 5 | sec |
| PIP 0.1%-SLS 1 mM/TMC 0.1%-SLS 1 mM-hex- | HPAN | PIP | [0.1] | SLS | [1.0] | TMC/hexane | [0.1] | 5 | sec |
| 5 s | | | | | | | | | |

*pH of the aqueous phase was adjusted with addition of NaOH.

### Example 3

### Process of Isolating the Polymer Separation Layer of a Composite Membrane and Making Freestanding Nanofilm

We used a nanofilm composite membrane made via interfacial polymerization of PIP and TMC on PAN support, a thin film composite membrane prepared on conventional support prepared via interfacial polymerization of MPD and TMC on PAN support and a commercial TFC nanofiltration membrane. The composite membranes were allowed to swell in acetone by dipping in acetone for 30 min. The support membrane along with the nanofilm/thin film was peeled-off from the nonwoven fabric with the help of an adhesive tape. The adhesive tape was adhered on the top (nanofilm side) of the composite membrane from one edge and the nonwoven fabric was peeled-off by detaching the ultrafiltration support (along with the nanofilm) from the fabric. Acetone was added during this process to help separating the layers. The nanofilm along with the support was then cut to make a small piece and floated on the surface of DMF containing 2 v/v % of water and waited for overnight. During this time, water contained DMF solution slowly dissolved the polymer support leaving only the nanofilm layer floating on the solution surface. Freestanding nanofilm was then transferred on different supports, such as anodic alumina, silicon, copper grid, where the rear side (facing aqueous phase during interfacial polymerization) of the nanofilm resided on the support and the top surface (facing organic phase during interfacial polymerization) remained on the top. Finally, the support containing nanofilm was dried at room temperature, washed in methanol and finally dried in a hot air oven at a temperature of 50 (±1) ° C. for 30 min and used for characterization.

### Example 4

### Analysis of Surface Morphology and Estimation of Thickness of the Nanofilms by Scanning Electron Microscopy (SEM)

Scanning electron microscope (SEM; JEOL, JSM 7100F) was used to analyze the surface morphology and the cross-sectional image of the nanofilms and composite membranes. Sample surface was coated with a 2-5 nm thick gold-palladium coating sputtered deposited from EM ACE200, Leica Microsystems, GmbH, Germany, prior to the SEM study. To avoid overestimation in the thickness, because of the effect of the surface deposition via coating, only relatively thicker samples of thickness above 20 nm were analyzed under SEM. To measure the thickness of the nanofilm, a freestanding polymer nanofilm was transferred onto the porous alumina and/or silicon wafer support and dried at room temperature. Nanofilm along with the support was then cleaned in methanol by immersing it for 10 min in methanol and then dried by putting in a hot air oven at 50 (±1) ° C. for 10 min. A small piece was fractured-cut from the support along with the nanofilm and placed vertically in the SEM sample stab to observe the nanofilm cross-section under SEM.

### Example 5

Study the Surface Morphology and Estimation of Thickness of the Nanofilms by Atomic Force Microscopy (AFM)

The surface morphology such as roughness and thickness of the nanofilm was measured by NT-MDT Spectrum Instruments, NTEGRA Aura Atomic Force Microscope (AFM) with a pizzo-type scanner with NSG10 series AFM cantilever. Length, width and thickness of the cantilever was 95 μm, 30 μm and 2 μm, respectively. Typical resonant frequency and force constant was 240 kHz and 11.8 N/m, respectively. A few samples were also characterized with Bruker Dimension 3100 and the images were captured under tapping mode using PointProbe® Plus silicon-SPM probe.

For the measurement of thickness, the freestanding nanofilm was transferred onto a silicon wafer and a scratch was made to expose the wafer surface and allow measurement of the height from the silicon wafer surface to the upper nanofilm surface. The step height is an estimation of the thickness of the nanofilm. A sampling resolution of 256 or 512 points per line and a speed of 0.5 to 1.0 Hz were used. Gwyddion 2.52 SPM data visualization and analysis software was used for image processing.

### Example 6

Measurement of Contact Angle of the Nanofilm Composite Membranes

Contact angle of the composite membranes was measured with water on a drop shape analyzer (DSA100, KRUSS, GmbH, Germany). At least five measurements were taken to measure an average value of the contact angle.

### Example 7

Estimation of Thickness of the Nanofilms by Light Interferometry

The thickness of the freestanding polymer nanofilms transferred onto silicon wafers was measured by light interferometry technique. A general-purpose film thickness measurement instrument (Filmetrics F20-UV, San Diego, USA) was employed to estimate the thickness value of the polymer nanofilm measured from two different positions on the sample surface. Results are presented in Table 2.

### Example 8

Evaluation of Elemental Composition of the Nanofilms by X-Ray Photoelectron Spectroscopy (XPS)

Polymer nanofilms were made freestanding and transferred onto a PLATYPUS™ gold coated silicon wafer as described above. The gold coated silicon wafer containing nanofilm was then dried at room temperature, washed in methanol and finally dried in a hot air oven at a temperature of 50 (±1) ° C. for 10 min. The XPS analysis was carried out at the Department of Central Scientific Service, Indian Association for the Cultivation of Science, Kolkata, India, using an Omicron Nanotechnology spectrometer using 300 W monochromatic AlKα X-ray as an excitation source.

The survey spectra and the core level XPS spectra were recorded from at least three different spots on the samples. The analyzer was operated at constant pass energy of 20 eV and setting the Cls peak at BE 285 eV to overcome any sample charging. Data processing was performed using CasaXps processing software (http://www.casaxps.com/). Peak areas were measured after satellite subtraction and background subtraction either with a linear background or following the methods of Shirley. (D. A. Shirley, High-resolution X-ray photoemission spectrum of the valence bands of gold, Phys. Rev. B 5, 4709, 1972).

### Example 9

Surface Morphology of the Nanofilm Composite Membranes Observed Under SEM

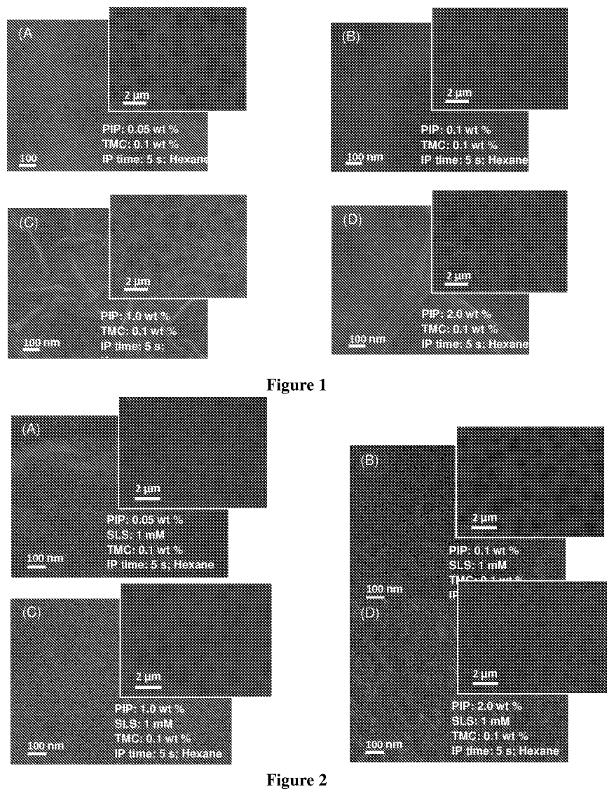

SEM was used to analyze the surface morphology of the membranes and the results are presented in FIGS. 1 and 2. The nanofilm membranes were prepared with PIP and TMC via interfacial polymerization on HPAN support. Excess hexane solution containing TMC was removed soon after the reaction and the unreacted TMC remained on the nanofilm surface was further removed by washing with pure hexane and dried at room temperature for 10 s. The composite membranes were finally annealed at 70 (±1) ° C. for 1 min in a hot air oven. SEM images are captured on the nanofilm composite membrane without removing the support.

### Example 10

Measurement of Thickness of the Polymer Nanofilms Via Cross-Sectional SEM

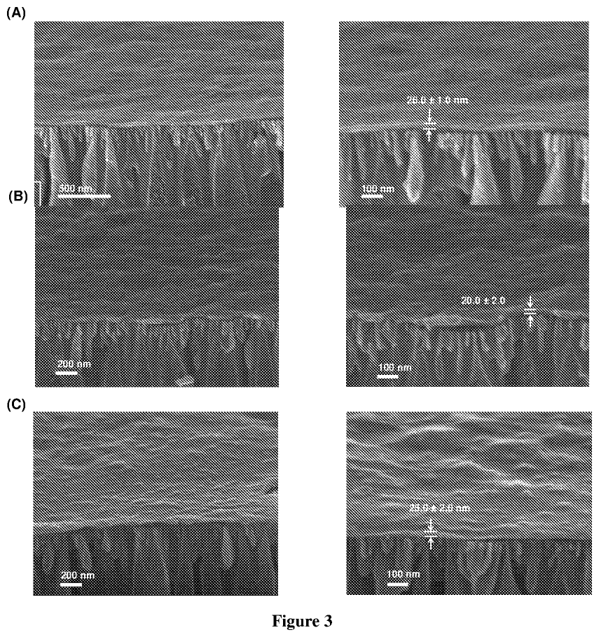

SEM was used to estimate the thickness of the freestanding nanofilms transferred onto the support. Images are presented in FIG. 3 and the results are summarized in Table 2. The nanofilm membranes were prepared with PIP and TMC via interfacial polymerization on HPAN support.

### Example 11

Surface Morphology and the Estimation of Thickness of the Freestanding Nanofilms from AFM Analysis

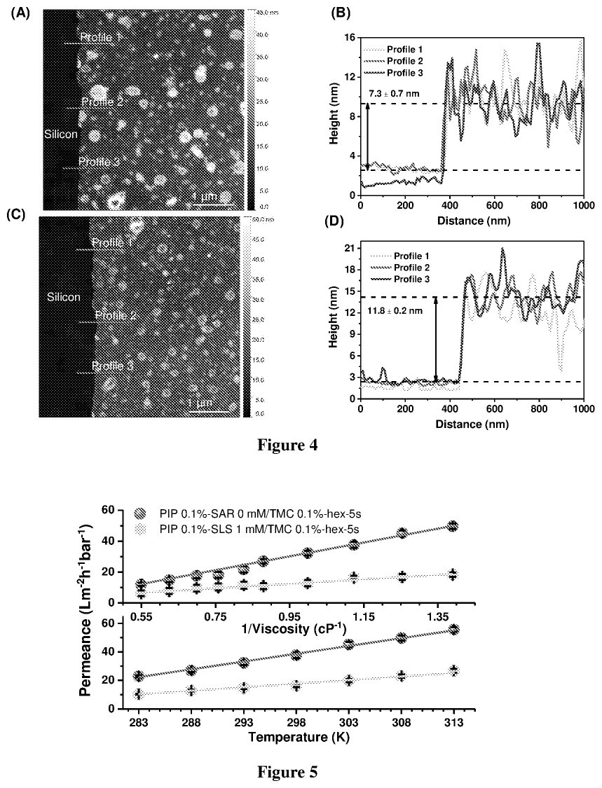

The surface morphology and the thickness of the freestanding nanofilms were determined from AFM analysis. Nanofilms of thickness preferably below 20 nm was measured by this technique. Results are tabulated in table 2 and FIG. 4.

TABLE 2
Thickness measurement of the freestanding nanofilms by using different
measurement techniques:
Table 2

| Preparation conditions | Thickness (nm) measured from | | |
|---|---|---|---|
| of the nanofilm | | | Light |
| composite membranes | AFM | SEM | Interferometry |
| PIP 0.05%-SAR 0 mM/TMC 0.05%-hex-5 s | 7.3 ± 0.7 | — | — |
| PIP 0.05%-SAR 0 mM/TMC 0.1%-hex-5 s | 11.8 ± 0.2 | — | 10.0 ± 2.9 |
| PIP 0.1%-SAR 0 mM/TMC 0.1%-hex-5 s | 18.0 ± 1.1 | — | — |
| PIP 0.5%-SAR 0 mM/TMC 0.1%-hex-5 s | — | 20.0 ± 2.0 | — |
| PIP 1.0%-SAR 0 mM/TMC 0.1%-hex-5 s | 20.0 ± 1.0 | — | — |
| PIP 2.0%-SAR 0 mM/TMC 0.1%-hex-5 s | — | 25.0 ± 2.0 | — |
| PIP 0.05%-SLS 1 mM/TMC 0.1%-hex-5 s | 12.1 ± 1.5 | — | 20.0 ± 1.8 |
| PIP 0.1%-SLS 1 mM/TMC 0.1%-hex-5 s | 20.6 ± 0.4 | 26.0 ± 1.0 | 21.7 ± 4.1 |
| PIP 0.5%-SLS 1 mM/TMC 0.1%-hex-5 s | 32.9 ± 0.3 | 40.0 ± 2.0 | — |
| PIP 1.0%-SLS 1 mM/TMC 0.1%-hex-5 s | — | 71.0 ± 7.0 | 96.6 ± 6.2 |
| PIP 2.0%-SLS 1 mM/TMC 0.1%-hex-5 s | — | 94.0 ± 4.0 | — |
| PIP 0.05%-SLS 1 mM/TMC 0.15%-hex-5 s | 12.4 ± 0.8 | 13.0 ± 1.5 | — |
| PIP 0.1%-SLS 1 mM/TMC 0.15%-hex-5 s | 16.4 ± 1.2 | 21.5 ± 2.0 | — |
| PIP 0.5%-SLS 1 mM/TMC 0.15%-hex-5 s | — | 50.0 ± 3.0 | — |
| PIP 1.0%-SLS 1 mM/TMC 0.15%-hex-5 s | — | 93.0 ± 13.0 | — |
| PIP 2.0%-SLS 1 mM/TMC 0.15%-hex-5 s | — | 149.0 ± 15.0 | 150.9 ± 11.0 |

### Example 12

Determination of the Surface Charge of the Nanofilm Composite Membranes:

The surface charge of the membranes was evaluated in a range of pH (pH 3-pH 9) using Zeta Cad streaming current & zeta potential meter, CAD Instruments, France. The results are presented in Table 3. The water-wetted composite membrane samples were placed in the dedicated test cell. The zeta potential values were recorded at different pH using 1 mM KCl electrolyte solution. A pair of rectangular nanofilm composite membranes fabricated on the HPAN support are used to measure the surface charge. At least two sets of experiments were carried out to obtain the mean value and the standard deviation of the measurement.

TABLE 3
Zeta potential of the membranes were measured at different pH of the electrolyte
solution. pH of the electrolyte solution was adjusted by using potassium hydroxide (KOH)
as base and hydrochloric acid (HCl) as acid.
Table 3

| Preparation conditions of the | Zeta potential (mV) measured at different pH | | | |
|---|---|---|---|---|
| nanofilm composite membranes | pH 3.0 | pH 5.0 | pH 7.0 | pH 9.0 |
| PIP 0.1%-SAR 0 mM/TMC 0.1%-hex-5 s | 16.1 ± 0.1 | −20.3 ± 0.3 | −23.4 ± 1.3 | −30.2 ± 0.1 |
| PIP 0.1%-SAR 0 mM/TMC 0.15%-hex-5 s | 10.8 ± 0.1 | −25.3 ± — | −27.2 ± 2.4 | −26.2 ± — |
| PIP 0.1%-SLS 1 mM/TMC 0.1%-hex-5 s | 12.4 ± 2.8 | −22.2 ± 0.1 | −26.0 ± 3.5 | −23.4 ± 1.8 |
| PIP 0.1%-SLS 1 mM/TMC 0.15%-hex-5 s | 14.4 ± 0.7 | −26.3 ± 1.3 | −26.8 ± 1.6 | −24.5 ± 1.3 |
| PIP 1.0%-SLS 1 mM/TMC 0.1%-hex-5 s | 10.8 ± 0.1 | −10.7 ± 0.3 | −18.8 ± 0.8 | −21.9 ± — |
| PIP 2.0%-SLS 1 mM/TMC 0.15%-hex-5 s | 8.5 ± 0.5 | −7.1 ± 0.4 | −12.2 ± 0.8 | −14.2 ± 1.1 |

### Example 13

Determination of the Elemental Composition of the Nanofilms by XPS

The elemental composition was estimated by XPS study of the freestanding nanofilms transferred onto gold coated silicon wafer. The results are obtained from the survey spectra and are summarized in Table 4.

TABLE 4
Elemental composition of the freestanding polymer nanofilms.
Table 4

| | Elemental composition obtained from XPS | | |
|---|---|---|---|
| Preparation conditions of the nanofilm | Carbon | Nitrogen | Oxygen |
| composite membranes | (C) % | (N) % | (O) % |

The front surface of the freestanding nanofilm is on the top

| | | | |
|---|---|---|---|
| PIP 0.05%-SAR 0 mM/TMC 0.1%-hex-5 s | 73.5 ± 0.4 | 10.6 ± 0.2 | 15.9 ± 0.6 |
| PIP 0.05%-SLS 1 mM/TMC 0.1%-hex-5 s | 71.4 ± 1.2 | 7.5 ± 0.7 | 21.1 ± 0.5 |
| PIP 0.1%-SAR 0 mM/TMC 0.1%-hex-5 s | 74.2 ± 0.3 | 9.2 ± 0.2 | 16.6 ± 0.4 |
| PIP 0.1%-SLS 1 mM/TMC 0.1%-hex-5 s | 73.8 ± 1.5 | 7.9 ± 0.5 | 18.2 ± 1.2 |
| PIP 1.0%-SAR 0 mM/TMC 0.1%-hex-5 s | 72.6 ± 0.9 | 11.1 ± 0.9 | 16.3 ± 1.1 |
| PIP 1.0%-SLS 1 mM/TMC 0.1%-hex-5 s | 74.8 ± 0.9 | 12.8 ± 0.8 | 12.4 ± 0.3 |
| PIP 2.0%-SLS 1 mM/TMC 0.15%-hex-5 s | 73.6 ± 0.9 | 10.9 ± 0.8 | 15.5 ± 0.4 |

The rear surface of the freestanding nanofilm is on the top

| | | | |
|---|---|---|---|
| PIP 0.1%-SAR 0 mM/TMC 0.1%-hex-5 s | 75.2 ± 0.6 | 12.1 ± 0.3 | 12.7 ± 0.3 |
| PIP 0.1%-SLS 1 mM/TMC 0.1%-hex-5 s | 74.3 ± 0.6 | 11.8 ± 0.1 | 13.9 ± 0.6 |
| PIP 1.0%-SLS 1 mM/TMC 0.1%-hex-5 s | 74.7 ± 0.3 | 17.5 ± 0.2 | 7.8 ± 0.5 |

### Example 14

Desalination Performance Evaluation of the Nanofilm Composite Membranes

The desalination performance of the nanofilm composite membranes was studied in a cross-flow desalination test unit consisted of an assembly of twelve SS316 cells where four cells were connected in series of each row. Each cell can accommodate a circular membrane coupon of diameter 0.043 m. Liquid flow rate was adjusted in the range of 50 Lh⁻¹-150 Lh⁻¹ by controlling the revolution of the high pressure pump connected to the assembly via a frequency drive control. Temperature of the feed solution was kept constant through a temperature controller and a heat exchanger in the form of a coolant jacket outside the feed tank. The solutes used in our study includes (i) salts (NaCl, KCl, MgCl₂, CaCl₂, MgSO₄, K₂SO₄ and Na₂SO₄), (ii) carbohydrates (glucose, sucrose and raffinose) and iii) dyes (sodium-2-naphthol-6-sulfonate hydrate, acid orange 7, orange G, acid fuchsin, brilliant blue R, rhodamine B, crystal violate, toluidine blue O, basic fuchsin and crysodine G). Experiments were performed under a varying applied pressure from 1-20 bar with salt concentration in the range of 0.5-80 gL⁻¹ as feed solution and maintaining the feed temperature at 25 (±1) ° C. All results were collected after allowing the membrane to reach at the steady state where the pure water permeance of the membrane was almost constant. This was achieved by waiting for 7 hours under cross-flow at 5 bar pressure, and 3 hours under cross-flow at 20 bar pressure with pure water as feed. The permeance of the membrane was calculated by the following equation:

J=V/A·t (i)

where V is the volume of the permeate (liter), A is the surface area of the membrane (m²) and t is the time in hour. The rejection of the membranes was calculated from the conductivity ratio between the difference of feed and permeate concentrations to the feed concentrations.

$$Rejection ( \% ) = ( 1 - \frac{{C}_{p}}{{C}_{f}} ) \times 100 \qquad ( ii )$$

where Cₚ is the concentration of the dissolved salt in the permeate and C_{f} is the concentration of the dissolved salt in the feed side.

Ion (or salt) selectivity is represented by

$$Selectivity = \frac{100 - rejection of {1}^{st} ion ( or salt )}{100 - rejection of {2}^{nd} ion ( or salt )} \qquad ( iii )$$

Double pass RO treated water (conductivity <2 μS) was used for the measurement of pure water permeance as well as for making feed solutions. An electrical conductivity meter (Eutech PC2700; CONSEN9201D with cell constant K=0.530) was used to measure the conductivity of the samples in the range of a few microSiemens (μS) to a few milliSiemens (mS). The conductivity of the permeate samples, where the measured conductivity was above 10 μS, and the conductivity of the feed sample was measured to calculate the salt rejection using equation (ii). The conductivity of the permeate sample, where the measured conductivity was below 10 μS, the inductively coupled plasma mass spectrometry (ICP-MS) and ion chromatography (IC) was used to measure the ion concentration in the sample. Both feed and permeate samples were analyzed with ICP-MS and IC after necessary dilution. Rejection and selectivity was determined using equation (ii) and (iii) respectively.

### Example 15

Study of the Solvent (Water) Transport Though Polyamide Nanofilm Composite Membranes at Different Viscosity and Temperatures:

Permeance of the polyamide composite membranes at different viscosity and at different temperature of the feed solution are recorded and presented in Table 5 and FIG. 5, respectively. Performance was conducted in a cross-flow filtration system with the cross-flow value of 50 Lh⁻¹ under 5 bar applied pressure.

TABLE 5
Permeance of the nanofilm composite membranes under different feed composition
with varying viscosity.
Table 5

| | | Permeance (Lm⁻²h⁻¹bar⁻¹) | |
|---|---|---|---|
| | | PIP: 0.1 wt %; SAR: | PIP: 0.1 wt %; SLS: 1 |
| | Viscosity | 0 mM; TMC: 0.1 wt | mM; TMC: 0.1 wt %; |
| Feed solution | (cP) | %; IP time: 5 s | IP time: 5 s |
| Pure water @ 35° C. | 0.72 | 44.8 ± 2.5 | 18.3 ± 1.3 |
| Pure water @ 30° C. | 0.79 | 39.1 ± 2.2 | 16.7 ± 2.0 |
| Pure water @ 25° C. l | 0.89 | 37.6 ± 1.9 | 16.4 ± 1.1 |
| Pure water @ 20° C. | 1.00 | 29.3 ± 1.8 | 12.8 ± 2.1 |
| Pure water @ 15° C. | 1.14 | 24.8 ± 1.5 | 10.9 ± 2.0 |
| MeOH:Water (1:9 by v/v %) @ 25° C. | 1.21 | 25.5 ± 1.7 | 11.6 ± 2.3 |
| MeOH:Water (1:9 by v/v %) @ 20° C. | 1.32 | 23.0 ± 1.6 | 10.3 ± 2.2 |
| MeOH:Water (1:4 by v/v %) @ 25° C. | 1.43 | 21.8 ± 1.4 | 9.5 ± 2.2 |
| MeOH:Water (1:4 by v/v %) @ 20° C. | 1.60 | 18.0 ± 1.4 | 7.8 ± 2.0 |
| MeOH:Water (1:4 by v/v %) @ 15° C. | 1.82 | 14.7 ± 1.0 | 6.3 ± 1.7 |

### Example 16

Evaluation of Fouling Behavior of the Nanofilm Composite Membranes

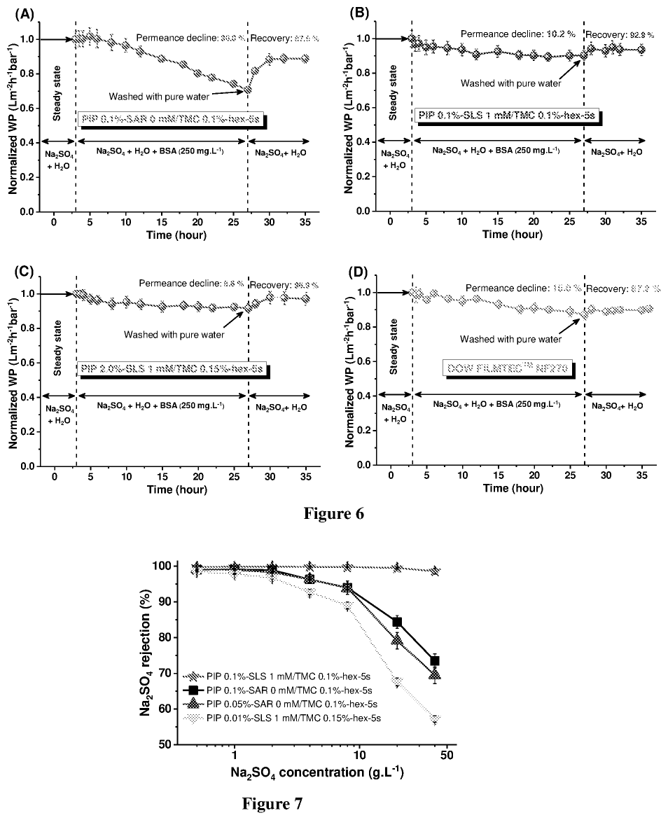

The fouling behavior of the membranes was evaluated during desalination of salt solution with BSA (250 mgL⁻¹) addition. Results are presented in FIG. 6. Briefly, the membrane coupons were pressurized by using pure water at a pressure of 5 bar and allow to reach the steady state. Na₂SO₄ (2 gL⁻¹) was then added and waited for additional 3 h prior to the measurement of the rejection of Na₂SO₄ and water permeance. BSA was then added into the feed to a concentration of 250 mgL⁻¹ and the system was allowed to run continuously for 24 h. The water permeance and Na₂SO₄ rejection was recorded with time. The antifouling property was determined by permeance reduction (PR) and permeance recovery ratio (PRR) as per the following equations (Eq. iv and Eq. v).

$$PR = \frac{{J}_{0} - {J}_{t}}{{J}_{0}} \times 100 \% \qquad ( iv )$$

$$PRR = \frac{{J}_{c}}{{J}_{0}} \times 100 \% \qquad ( v )$$

where Jₒ and Jₜ are the initial permeance during desalination (containing only salt in feed water) and the permeate flux at a given time of desalination (containing salt in feed water contaminated with BSA), respectively. After 24 h of operation with BSA/salt solution, membranes were washed with pure water for 30 min. Then, the permeance (J_{c}) and rejection of the membranes were measured with Na₂SO₄ as feed (2 gL⁻¹).

### Example 17

Desalination Performance of the Nanofilm Composite Membranes

Desalination performance of the nanofilm composite membranes were studied with pure salt feed, mixed salt feed with two salts, mixed salt feed with four salts and synthetic sea water feed. The pure water permeance, salt rejection and ion selectivity (separation factor) are estimated. The results are summarized in Tables 6-10.

TABLE 6
Table 6. Permeance behaviour of the polyamide nanofilms composite membranes fabricated
on HPAN support. Membranes were tested under 5 bar operating pressure at 25 (±1)°
C. with a feed of salt concentration 2 gL⁻¹ and a cross-flow velocity of 50 Lh⁻¹.

| Preparation conditions | Contact | Nanofiltration performance | | | | | | | | |
|---|---|---|---|---|---|---|---|---|---|---|
| of the nanofilm | angle | | Pure | | | | | | | |
| composite membranes | (degree) | Feed [symbol] | water | Na₂SO₄ | MgCl₂ | NaCl | K₂SO₄ | CaCl₂ | MgSO₄ | KCl |
| PIP: 0.05 wt %; | 41.5 ± | Water | 47.9 ± | 24.0 ± | 47.1 ± | 40.2 ± | — | 45.9 ± | 31.3 ± | |
| SAR: 0 mM | 1.3 | permeance | 5.0 | 1.4 | 5.8 | 4.4 | | 5.0 | 1.6 | |
| TMC: 0.05 wt % | | (Lm⁻²h⁻¹bar⁻¹) | | | | | | | | |
| IP time: 5 s; | | Salt rejection | — | 98.47 ± | 10.0 ± | 14.2 ± | — | 6.9 ± | 89.9 ± | — |
| Hexane | | (%) | | 0.76 | 5.4 | 3.8 | | 3.7 | 5.8 | |
| PIP: 0.1 wt %; | 36.5 ± | Water | 30.6 ± | 17.2 ± | 28.5 ± | 25.4 ± | 18.4 ± | 29.8 ± | 23.2 ± | 26.6 ± |
| SAR: 0 mM | 1.7 | permeance | 1.0 | 0.8 | 0.9 | 1.1 | 0.8 | 1.5 | 0.9 | 1.1 |
| TMC: 0.05 wt % | | (Lm⁻²h⁻¹bar⁻¹) | | | | | | | | |
| IP time: 5 s; | | Salt rejection | — | 98.30 ± | 15.6 ± | 18.6 ± | 98.2 ± | 16.3 ± | 94.2 ± | 20.2 ± |
| Hexane | | (%) | | 0.48 | 1.0 | 1.0 | 0.5 | 1.4 | 1.7 | 0.7 |
| PIP: 1.0 wt %; | 35.0 ± | Water | 24.7 ± | 16.7 ± | 18.0 ± | 22.7 ± | 18.8 ± | 18.3 ± | 20.2 ± | 23.3 ± |
| SAR: 0 mM | 2.9 | permeance | 1.6 | 0.9 | 1.1 | 1.3 | 0.9 | 1.2 | 1.2 | 1.4 |
| TMC: 0.05 wt % | | (Lm⁻²h⁻¹bar⁻¹) | | | | | | | | |
| IP time: 5 s; | | Salt rejection | — | 99.59 ± | 80.5 ± | 26.7 ± | 99.6 ± | 82.9 ± | 99.4 ± | 26.2 ± |
| Hexane | | (%) | | 0.21 | 4.0 | 0.5 | 0.1 | 3.9 | 0.1 | 0.6 |
| PIP: 2.0 wt %; | 39.7 ± | Water | 17.6 ± | 11.7 ± | 11.1 ± | 14.1 ± | — | — | — | — |
| SAR: 0 mM | 1.2 | permeance | 0.9 | 0.5 | 0.5 | 0.7 | | | | |
| TMC: 0.05 wt % | | (Lm⁻²h⁻¹bar⁻¹) | | | | | | | | |
| IP time: 5 s; | | Salt rejection | — | 98.65 ± | 96.9 ± | 38.4 ± | — | — | — | — |
| Hexane | | (%) | | 0.38 | 0.6 | 1.1 | | | | |
| PIP: 0.05 wt %; | 46.8 ± | Water | 57.1 ± | 40.9 ± | 52.3 ± | 53.0 ± | — | 47.0 ± | 39.2 ± | — |
| SAR: 0 mM | 3.2 | permeance | 1.9 | 0.9 | 2.2 | 2.3 | | 2.3 | 1.6 | |
| TMC: 0.1 wt % | | (Lm⁻²h⁻¹bar⁻¹) | | | | | | | | |
| IP time: 5 s; | | Salt rejection | — | 98.32 ± | 4.5 ± | 15.3 ± | — | 5.0 ± | 84.1 ± | — |
| Hexane | | (%) | | 0.19 | 0.4 | 0.8 | | 0.4 | 1.9 | |
| PIP: 0.1 wt %; | 41.2 ± | Water | 37.6 ± | 21.1 ± | 34.8 ± | 35.6 ± | — | 37.3 ± | 28.6 ± | 38.5 ± |
| SAR: 0 mM | 2.1 | permeance | 1.9 | 0.6 | 2.4 | 1.9 | | 2.8 | 1.2 | 1.5 |
| TMC: 0.1 wt % | | (Lm⁻²h⁻¹bar⁻¹) | | | | | | | | |
| IP time: 5 s; | | Salt rejection | — | 98.94 ± | 7.8 ± | 16.2 ± | — | 8.9 ± | 88.1 ± | 15.9 ± |
| Hexane | | (%) | | 0.37 | 3.1 | 3.6 | | 2.2 | 4.4 | 2.8 |
| PIP: 1.0 wt %; | 44.6 ± | Water | 19.3 ± | 12.5 ± | 14.9 ± | 17.0 ± | 11.0 ± | 13.7 ± | 16.1 ± | 16.4 ± |
| SAR: 0 mM | 2.0 | permeance | 1.4 | 1.8 | 2.7 | 1.1 | 0.6 | 0.6 | 2.4 | 0.9 |
| TMC: 0.1 wt % | | (Lm⁻²h⁻¹bar⁻¹) | | | | | | | | |
| IP time: 5 s; | | Salt rejection | — | 99.65 ± | 73.4 ± | 37.9 ± | 99.6 ± | 63.0 ± | 98.7 ± | 15.2 ± |
| Hexane | | (%) | | 0.19 | 2.5 | 2.9 | 0.1 | 2.8 | 0.4 | 1.5 |
| PIP: 2.0 wt %; | 43.3 ± | Water | 18.6 ± | 11.9 ± | 14.5 ± | 16.9 ± | 13.5 ± | 15.4 ± | 16.0 ± | 17.3 ± |
| SAR: 0 mM | 2.0 | permeance | 1.7 | 1.0 | 1.4 | 1.2 | 1.0 | 1.5 | 1.4 | 1.0 |
| TMC: 0.1 wt % | | (Lm⁻²h⁻¹bar⁻¹) | | | | | | | | |
| IP time: 5 s; | | Salt rejection | — | 98.60 ± | 75.4 ± | 24.2 ± | 98.6 ± | 68.8 ± | 97.5 ± | 35.6 ± |
| Hexane | | (%) | | 0.7 | 1.9 | 1.6 | 0.8 | 2.9 | 1.1 | 1.2 |
| PIP: 0.05 wt %; | 43.7 ± | Water | 59.6 ± | 29.0 ± | 61.5 ± | 51.7 ± | — | 57.0 ± | 40.5 ± | — |
| SAR: 0 mM | 1.7 | permeance | 2.5 | 1.1 | 2.6 | 1.5 | | 3.8 | 2.8 | |
| TMC: 0.15 wt % | | (Lm⁻²h⁻¹bar⁻¹) | | | | | | | | |
| IP time: 5 s; | | Salt rejection | — | 91.77 ± | 3.2 ± | 8.9 ± | — | 2.0 ± | 58.8 ± | — |
| Hexane | | (%) | | 1.24 | 0.4 | 0.5 | | 0.3 | 4.0 | |
| PIP: 0.1 wt %; | 47.5 ± | Water | 30.6 ± | 16.3 ± | 32.2 ± | 27.9 ± | 20.6 ± | 28.8 ± | 25.0 ± | 28.7 ± |
| SAR: 0 mM | 4.0 | permeance | 3.3 | 2.2 | 2.9 | 3.1 | 2.3 | 2.7 | 1.9 | 3.0 |
| TMC: 0.15 wt % | | (Lm⁻²h⁻¹bar⁻¹) | | | | | | | | |
| IP time: 5 s; | | Salt rejection | — | 97.37 ± | 5.6 ± | 17.1 ± | 97.3 ± | 6.3 ± | 81.5 ± | 15.7 ± |
| Hexane | | (%) | | 1.15 | 0.8 | 1.5 | 0.7 | 1.7 | 0.3 | 1.6 |
| PIP: 1.0 wt %; | 39.9 ± | Water | 15.9 ± | 11.0 ± | 15.8 ± | 17.1 ± | 13.9 ± | 15.9 ± | 13.7 ± | 17.1 ± |
| SAR: 0 mM | 2.3 | permeance | 2.5 | 1.7 | 2.5 | 2.2 | 1.7 | 1.8 | 1.7 | 2.2 |
| TMC: 0.15 wt % | | (Lm⁻²h⁻¹bar⁻¹) | | | | | | | | |
| IP time: 5 s; | | Salt rejection | — | 99.63 ± | 20.5 ± | 30.1 ± | 99.5 ± | 21.3 ± | 98.1 ± | 31.5 ± |
| Hexane | | (%) | | 0.20 | 0.4 | 2.2 | 0.03 | 1.8 | 0.3 | 3.1 |
| PIP: 2.0 wt %; | 41.8 ± | Water | 14.7 ± | 11.0 ± | 12.3 ± | 12.3 ± | 11.4 ± | 12.7 ± | 11.5 ± | 12.8 ± |
| SAR: 0 mM | 3.0 | permeance | 1.4 | 1.2 | 1.0 | 1.6 | 1.6 | 1.0 | 1.0 | 1.6 |
| TMC: 0.15 wt % | | (Lm⁻²h⁻¹bar⁻¹) | | | | | | | | |
| IP time: 5 s; | | Salt rejection | — | 98.75 ± | 65.5 ± | 47.9 ± | 98.3 ± | 52.3 ± | 97.2 ± | 46.1 ± |
| Hexane | | (%) | | 0.71 | 6.3 | 4.9 | 0.4 | 8.4 | 0.3 | 4.7 |
| PIP: 0.05 wt %; | 32.2 ± | Water | 22.6 ± | 17.3 ± | 14.8 ± | 18.6 ± | 11.5 ± | 12.7 ± | 13.8 ± | 15.8 ± |
| SLS: 1 mM | 1.6 | permeance | 1.8 | 1.7 | 1.8 | 2.3 | 0.8 | 0.6 | 0.7 | 1.2 |
| TMC: 0.05 wt % | | (Lm⁻²h⁻¹bar⁻¹) | | | | | | | | |
| IP time: 5 s; | | Salt rejection | — | 99.92 ± | 94.6 ± | 41.1 ± | 99.6 ± | 81.1 ± | 99.2 ± | 28.7 ± |
| Hexane | | (%) | | 0.08 | 0.7 | 5.4 | 0.1 | 1.4 | 0.1 | 1.0 |
| PIP: 0.1 wt %; | 41.5 ± | Water | 14.2 ± | 12.0 ± | 10.1 ± | 12.3 ± | — | 10.3 ± | 11.7 ± | 12.1 ± |
| SLS: 1 mM | 1.3 | permeance | 0.8 | 0.5 | 0.4 | 0.8 | | 0.4 | 0.3 | 0.4 |
| TMC: 0.05 wt % | | (Lm⁻²h⁻¹bar⁻¹) | | | | | | | | |
| IP time: 5 s; | | Salt rejection | — | 99.81 ± | 98.4 ± | 43.7 ± | — | 92.6 ± | 99.2 ± | 31.6 ± |
| Hexane | | (%) | | 0.09 | 0.3 | 4.9 | | 1.0 | 0.2 | 7.3 |
| PIP: 1.0 wt %; | 56.0 ± | Water | 13.7 ± | 12.7 ± | 10.5 ± | 13.9 ± | — | 11.4 ± | 14.4 ± | 14.1 ± |
| SLS: 1 mM | 1.1 | permeance | 4.4 | 3.3 | 3.0 | 4.2 | | 3.3 | 3.9 | 4.0 |
| TMC: 0.05 wt % | | (Lm⁻²h⁻¹bar⁻¹) | | | | | | | | |
| IP time: 5 s; | | Salt rejection | — | 32.55 ± | 89.5 ± | 30.7 ± | — | 88.4 ± | 79.4 ± | 30.5 ± |
| Hexane | | (%) | | 6.72 | 7.1 | 7.3 | | 9.5 | 9.5 | 9.7 |
| PIP: 2.0 wt %; | 54.4 ± | Water | 81.8 ± | 57.2 ± | 76.7 ± | 67.3 ± | — | — | — | — |
| SLS: 1 mM | 2.4 | permeance | 9.7 | 5.9 | 7.5 | 7.7 | | | | |
| TMC: 0.05 wt % | | (Lm⁻²h⁻¹bar⁻¹) | | | | | | | | |
| IP time: 5 s; | | Salt rejection | — | 10.5 ± | 2.1 ± | 3.1 ± | — | — | — | — |
| Hexane | | (%) | | 1.05 | 2.1 | 0.1 | | | | |
| PIP: 0.01 wt %; | — | Water | 59.0 ± | 37.0 ± | 50.2 ± | 49.3 ± | | 48.6 ± | 37.0 ± | |
| SLS: 1 mM | | permeance | 2.4 | 1.2 | 2.9 | 2.4 | | 2.3 | 1.3 | |
| TMC: 0.1 wt % | | (Lm⁻²h⁻¹bar⁻¹) | | | | | | | | |
| IP time: 5 s; | | Salt rejection | — | 98.18 ± | 7.9 ± | 9.7 ± | | 6.6 ± | 85.2 ± | |
| Hexane | | (%) | | 0.42 | 3.2 | 1.5 | | 2.7 | 3.4 | |
| PIP: 0.05 wt %; | — | Water | 25.5 ± | 19.5 ± | 17.3 ± | 21.5 ± | — | — | — | — |
| SLS: 0.5 mM | | permeance | 0.4 | 0.5 | 0.5 | 0.5 | | | | |
| TMC: 0.1 wt % | | (Lm⁻²h⁻¹bar⁻¹) | | | | | | | | |
| IP time: 5 s; | | Salt rejection | — | 99.87 ± | 88.9 ± | 39.7 ± | — | — | — | — |
| Hexane | | (%) | | 0.02 | 0.7 | 1.2 | | | | |
| PIP: 0.05 wt %; | 33.4 ± | Water | 23.1 ± | 17.4 ± | 15.6 ± | 20.5 ± | — | 16.5 ± | 18.0 ± | — |
| SLS: 1 mM | 3.0 | permeance | 1.7 | 1.1 | 1.0 | 1.7 | | 1.1 | 1.0 | |
| TMC: 0.1 wt % | | (Lm⁻²h⁻¹bar⁻¹) | | | | | | | | |
| IP time: 5 s; | | Salt rejection | — | 99.95 ± | 93.9 ± | 45.0 ± | — | 88.8 ± | 99.6 ± | — |
| Hexane | | (%) | | 0.03 | 2.7 | 0.3 | | 4.8 | 0.1 | |
| PIP: 0.05 wt %; | — | Water | 17.7 ± | 12.0 ± | 12.0 ± | 15.8 ± | 13.0 ± | 13.2 ± | 15.0 ± | 16.1 ± |
| SLS: 2 mM | | permeance | 0.6 | 0.6 | 0.5 | 0.5 | 0.6 | 0.5 | 0.6 | 0.6 |
| TMC: 0.1 wt % | | (Lm⁻²h⁻¹bar⁻¹) | | | | | | | | |
| IP time: 5 s; | | Salt rejection | — | 91.43 ± | 92.9 ± | 18.2 ± | 91.9 ± | 88.2 ± | 98.9 ± | 19.9 ± |
| Hexane | | (%) | | 5.33 | 0.6 | 1.6 | 4.9 | 0.6 | 0.2 | 1.0 |
| PIP: 0.05 wt %; | — | Water | 16.9 ± | 14.2 ± | 12.0 ± | 15.0 ± | 14.6 ± | 12.8 ± | 14.9 ± | 15.2 ± |
| SLS: 5 mM | | permeance | 1.1 | 1.6 | 0.9 | 1.2 | 1.6 | 1.0 | 1.2 | 1.3 |
| TMC: 0.1 wt % | | (Lm⁻²h⁻¹bar⁻¹) | | | | | | | | |
| IP time: 5 s; | | Salt rejection | — | 38.50 ± | 85.7 ± | 18.4 ± | 38.8 ± | 82.1 ± | 87.1 ± | 19.7 ± |
| Hexane | | (%) | | 3.61 | 3.8 | 1.4 | 3.5 | 4.1 | 2.7 | 2.0 |
| PIP: 0.05 wt %; | — | Water | 22.8 ± | 27.5 ± | 20.6 ± | 23.7 ± | 25.4 ± | 23.3 ± | 26.3 ± | 23.9 ± |
| SLS: 10 mM | | permeance | 1.4 | 1.4 | 1.0 | 1.0 | 1.3 | 1.0 | 1.2 | 1.3 |
| TMC: 0.1 wt % | | (Lm⁻²h⁻¹bar⁻¹) | | | | | | | | |
| IP time: 5 s; | | Salt rejection | — | 9.48 ± | 58.9 ± | 10.2 ± | 10.0 ± | 52.6 ± | 34.0 ± | 10.3 ± |
| Hexane | | (%) | | 1.63 | 9.7 | 0.3 | 2.6 | 7.2 | 2.3 | 0.7 |
| PIP: 0.1 wt %; | — | Water | 13.3 ± | 9.9 ± | 9.6 ± | 12.0 ± | — | — | — | — |
| SLS: 1 mM | | permeance | 1.1 | 0.9 | 0.9 | 1.1 | | | | |
| TMC: 0.1 wt % | | (Lm⁻²h⁻¹bar⁻¹) | | | | | | | | |
| IP time: 5 s; | | Salt rejection | — | 99.78 ± | 97.7 ± | 41.5 ± | — | — | — | — |
| Heptane | | (%) | | 0.02 | 0.3 | 2.0 | | | | |
| PIP: 0.1 wt %; | — | Water | 15.3 ± | 13.6 ± | 12.7 ± | 14.2 ± | — | — | — | — |
| SLS: 1 mM ; | | permeance | 1.4 | 0.9 | 1.2 | 1.2 | | | | |
| TMC: 0.1 wt % | | (Lm⁻²h⁻¹bar⁻¹) | | | | | | | | |
| IP time: 5 s; | | Salt rejection | — | 57.15 ± | 89.4 ± | 30.9 ± | — | — | — | — |
| Toluene | | (%) | | 4.38 | 1.0 | 1.2 | | | | |
| PIP: 0.1 wt %; | — | Water | 13.8 ± | 10.4 ± | 10.2 ± | 12.5 ± | — | — | — | — |
| SLS: 1 mM | | permeance | 0.5 | 0.4 | 0.4 | 0.5 | | | | |
| TMC: 0.1 wt % | | (Lm⁻²h⁻¹bar⁻¹) | | | | | | | | |
| IP time: 5 s; | | Salt rejection | — | 99.79 ± | 97.6 ± | 43.8 ± | — | — | — | — |
| Cyclohexane | | (%) | | 0.01 | 0.1 | 1.7 | | | | |
| PIP: 0.1 wt %; | 43.8 ± | Water | 16.4 ± | 12.4 ± | 12.6 ± | 13.7 ± | 11.2 ± | 12.9 ± | 12.4 ± | 13.1 ± |
| SLS: 1 mM | 2.4 | permeance | 1.1 | 0.8 | 0.7 | 1.0 | 1.0 | 0.7 | 1.3 | 1.0 |
| TMC: 0.1 wt % | | (Lm⁻²h⁻¹bar⁻¹) | | | | | | | | |
| IP time: 5 s; | | Salt rejection | — | 99.96 ± | 98.1 ± | 42.1 ± | 99.7 ± | 96.6 ± | 99.84 ± | 40.5 ± |
| Hexane | | (%) | | 0.03 | 0.1 | 1.8 | 0.1 | 0.3 | 0.1 | 1.5 |
| PIP: 0.1 wt %; | 32.3 ± | Water | 15.1 ± | 11.4 ± | 10.8 ± | 13.7 ± | 14.0 ± | 11.7 ± | 13.6 ± | 14.3 ± |
| SLS: 1 mM | 2.5 | permeance | 0.2 | 0.2 | 0.2 | 0.2 | 0.2 | 0.3 | 0.2 | 0.2 |
| TMC: 0.1 wt % | | (Lm⁻²h⁻¹bar⁻¹) | | | | | | | | |
| IP time: 30 s; | | Salt rejection | — | 99.98 ± | 97.8 ± | 42.9 ± | 99.87 ± | 96.1 ± | 99.77 ± | 45.9 ± |
| Hexane | | (%) | | 0.01 | 0.3 | 1.0 | 0.01 | 0.4 | 0.03 | 1.0 |
| PIP: 0.1 wt %; | 25.7 ± | Water | 11.9 ± | 9.7 ± | 8.8 ± | 10.8 ± | 11.5 ± | 9.6 ± | 11.1 ± | 11.3 ± |
| SLS: 1 mM | 2.0 | permeance | 0.6 | 0.6 | 0.5 | 0.7 | 0.7 | 0.6 | 0.6 | 0.7 |
| TMC: 0.1 wt % | | (Lm⁻²h⁻¹bar⁻¹) | | | | | | | | |
| IP time: 2 min; | | Salt rejection | — | 99.98 ± | 98.2 ± | 51.0 ± | 99.87 ± | 96.5 ± | 99.8 ± | 53.6 ± |
| Hexane | | (%) | | 0.01 | 0.1 | 0.9 | 0.03 | 0.2 | 0.03 | 0.9 |
| PIP: 0.1 wt %; | 33.7 ± | Water | 8.1 ± | 7.0 ± | 6.2 ± | 7.6 ± | 8.7 ± | 6.9 ± | 7.9 ± | 8.3 ± |
| SLS: 1 mM | 3.5 | permeance | 0.3 | 0.3 | 0.3 | 0.3 | 0.2 | 0.1 | 0.1 | 0.3 |
| TMC: 0.1 wt % | | (Lm⁻²h⁻¹bar⁻¹) | | | | | | | | |
| IP time: 20 min; | | Salt rejection | — | 99.99 ± | 98.0 ± | 56.9 ± | 99.88 ± | 95.8 ± | 99.8 ± | 58.6 ± |
| Hexane | | (%) | | 0.01 | 0.1 | 0.9 | 0.01 | 0.1 | 0.03 | 0.8 |
| PIP: 1.0 wt %; | 59.6 ± | Water | 7.4 ± | 7.1 ± | 5.8 ± | 6.7 ± | 8.3 ± | 7.1 ± | 6.9 ± | 7.1 ± |
| SLS: 1 mM | 2.1 | permeance | 1.0 | 0.5 | 0.7 | 1.1 | 0.4 | 0.5 | 1.2 | 1.1 |
| TMC: 0.1 wt % | | (Lm⁻²h⁻¹bar⁻¹) | | | | | | | | |
| IP time: 5 s; | | Salt rejection | — | 46.07 ± | 96.3 ± | 48.5 ± | 43.0 ± | 98.1 ± | 97.2 ± | 54.0 ± |
| Hexane | | (%) | | 3.97 | 0.9 | 1.8 | 3.0 | 0.1 | 0.5 | 1.8 |
| PIP: 2.0 wt %; | 56.9 ± | Water | 23.9 ± | 24.90 ± | 23.6 ± | 22.2 ± | — | — | — | — |
| SLS: 1 mM | 2.5 | permeance | 1.3 | 1.2 | 1.5 | 1.1 | | | | |
| TMC: 0.1 wt % | | (Lm⁻²h⁻¹bar⁻¹) | | | | | | | | |
| IP time: 5 s; | | Salt rejection | — | 10.67 ± | 30.5 ± | 13.8 ± | — | — | — | — |
| Hexane | | (%) | | 0.97 | 3.1 | 0.8 | | | | |
| PIP: 0.01 wt %; | — | Water | 58.8 ± | 37.4 ± | 50.2 ± | 48.4 ± | — | 47.7 ± | 37.2 ± | — |
| SLS: 1 mM | | permeance | 5.4 | 1.4 | 1.7 | 1.6 | | 1.5 | 0.2 | |
| TMC: 0.15 wt % | | (Lm⁻²h⁻¹bar⁻¹) | | | | | | | | |
| IP time: 5 s; | | Salt rejection | — | 96.78 ± | 2.7 ± | 10.3 ± | — | 4.6 ± | 73.9 ± | — |
| Hexane | | (%) | | 0.39 | 0.3 | 1.5 | | 3.9 | 1.0 | |
| PIP: 0.05 wt %; | 31.9 ± | Water | 22.2 ± | 15.7 ± | 15.1 ± | 18.0 ± | 16.0 ± | 17.1 ± | 17.7 ± | 19.5 ± |
| SLS: 1 mM | 2.7 | permeance | 1.7 | 1.6 | 0.3 | 0.6 | 0.3 | 0.3 | 0.4 | 0.1 |
| TMC: 0.15 wt % | | (Lm⁻²h⁻¹bar⁻¹) | | | | | | | | |
| IP time: 5 s; | | Salt rejection | — | 99.95 ± | 79.1 ± | 40.1 ± | 99.7 ± | 68.8 ± | 99.6 ± | 38.0 ± |
| Hexane | | (%) | | 0.03 | 0.8 | 0.3 | 0.03 | 1.4 | 0.1 | 0.8 |
| PIP: 0.1 wt %; | 40.2 ± | Water | 16.2 ± | 12.1 ± | 11.6 ± | 15.9 ± | 11.3 ± | 11.2 ± | 13.0 ± | 13.0 ± |
| SLS: 1 mM | 1.3 | permeance | 1.5 | 0.7 | 1.2 | 0.5 | 0.8 | 0.7 | 0.6 | 0.9 |
| TMC: 0.15 wt % | | (Lm⁻²h⁻¹bar⁻¹) | | | | | | | | |
| IP time: 5 s; | | Salt rejection | — | 99.91 ± | 96.7 ± | 44.6 ± | 99.8 ± | 92.7 ± | 99.6 ± | 35.1 ± |
| Hexane | | (%) | | 0.09 | 0.6 | 1.6 | 0.02 | 0.4 | 0.03 | 1.6 |
| PIP: 1.0 wt %; | 45.2 ± | Water | 6.1 ± | 4.9 ± | 4.7 ± | 5.2 ± | 5.2 ± | 4.9 ± | 5.7 ± | 5.6 ± |
| SLS: 1 mM | 2.3 | permeance | 0.9 | 0.9 | 0.9 | 0.7 | 0.9 | 0.8 | 0.8 | 0.8 |
| TMC: 0.15 wt % | | (Lm⁻²h⁻¹bar⁻¹) | | | | | | | | |
| IP time: 5 s; | | Salt rejection | — | 91.73 ± | 99.0 ± | 61.2 ± | 91.3 ± | 98.6 ± | 99.5 ± | 63.5 ± |
| Hexane | | (%) | | 6.06 | 0.1 | 2.8 | 6.6 | 0.01 | 0.1 | 3.3 |
| PIP: 2.0 wt %; | 58.0 ± | Water | 4.4 ± | 5.2 ± | 4.1 ± | 4.4 ± | 5.0 ± | 4.1 ± | 4.5 ± | 5.0 ± |
| SLS: 1 mM | 4.6 | permeance | 0.6 | 0.6 | 0.6 | 0.6 | 0.7 | 0.7 | 0.7 | 0.7 |
| TMC: 0.15 wt % | | (Lm⁻²h⁻¹bar⁻¹) | | | | | | | | |
| IP time: 5 s; | | Salt rejection | — | 39.93 ± | 98.4 ± | 54.5 ± | 43.7 ± | 97.7 ± | 97.8 ± | 56.8 ± |
| Hexane | | (%) | | 2.51 | 0.1 | 0.6 | 0.1 | 0.2 | 0.3 | 0.6 |
| PEI: 0.05 wt %; | — | Water | 25.2 ± | 16.8 ± | 22.8 ± | 24.7 ± | 17.8 ± | 24.0 ± | 20.0 ± | 24.8 ± |
| SAR: 0 mM | | permeance | 2.2 | 1.7 | 2.0 | 2.1 | 2.1 | 1.9 | 1.7 | 2.1 |
| TMC: 0.05 wt % | | (Lm⁻²h⁻¹bar⁻¹) | | | | | | | | |
| IP time: 5 s; | | Salt rejection | — | 92.8 ± | 10.1 ± | 9.1 ± | 92.7 ± | 13.7 ± | 71.9 ± | 8.8 ± |
| Hexane | | (%) | | 1.2 | 0.8 | 0.3 | 1.1 | 1.7 | 2.5 | 0.6 |
| PEI: 0.05 wt %; | — | Water | — | 16.1 ± | 21.4 ± | — | — | — | 18.5 ± | — |
| SLS: 1 mM; | | permeance | | 0.6 | 0.6 | | | | 0.3 | |
| TMC: 0.05 wt % | | (Lm⁻²h⁻¹bar⁻¹) | | | | | | | | |
| IP time: 5 s; | | Salt rejection | — | 62.20 ± | 8.3 ± | — | — | — | 43.1 ± | — |
| Hexane | | (%) | | 6.2 | 1.3 | | | | 4.7 | |
| Commercial | 62.4 | Water | 22.2 ± | 19.0 ± | 14.0 ± | 17.8 ± | — | 15.0 ± | 15.2 ± | 17.3 ± |
| nanofiltration | | permeance | 1.5 | 1.7 | 0.1 | 1.4 | | 0.1 | 0.2 | 0.2 |
| membrane Dow | | (Lm⁻²h⁻¹bar⁻¹) | | | | | | | | |
| FILMTEC ™ | | Salt rejection | — | 99.56 ± | 59.7 ± | 51.5 ± | — | 61.4 ± | 99.1 ± | 50.1 ± |
| NF270 (tested in | | (%) | | 0.10 | 1.8 | 2.2 | | 2.7 | 0.3 | 3.2 |
| our laboratory) | | | | | | | | | | |

TABLE 7
Table 7. Permeance behaviour of the polyamide nanofilms composite membranes fabricated
on different ultrafiltration supports. Membranes were tested under 5 bar operating pressure
at 25 (±1)° C. and 2 gL⁻¹ feed with a cross-flow velocity of 50 Lh⁻¹.

| Preparation conditions | | Nanofiltration performance | | | | | | | | |
|---|---|---|---|---|---|---|---|---|---|---|
| of the nanofilm | UF | | Pure | | | | | | | |
| composite membranes | support | Feed [symbol] | water | Na₂SO₄ | MgCl₂ | NaCl | K₂SO₄ | CaCl₂ | MgSO₄ | KCl |
| PIP: 0.1 wt %; | PAN | Water | 14.1 ± | 10.5 ± | 9.7 ± | 12.7 ± | 11.9 ± | 10.3 ± | 12.2 ± | 13.5 ± |
| SLS: 1 mM | | permeance | 0.7 | 0.5 | 0.6 | 0.7 | 0.5 | 0.7 | 0.5 | 0.6 |
| TMC: 0.1 wt % | | (Lm⁻²h⁻¹bar⁻¹) | | | | | | | | |
| IP time: 5 s; | | Salt rejection | — | 99.70 ± | 93.1 ± | 42.8 ± | 99.8 ± | 95.5 ± | 99.6 ± | 40.9 ± |
| Hexane | | (%) | | 0.02 | 2.2 | 1.1 | 0.02 | 2.2 | 0.1 | 1.6 |
| PIP: 0.1 wt %; | P84 | Water | 45.6 ± | 29.1 ± | 48.0 ± | 52.6 ± | 33.8 ± | 47.3 ± | 35.7 ± | 51.3 ± |
| SLS: 1 mM | | permeance | 4.2 | 2.1 | 4.5 | 4.9 | 2.9 | 4.8 | 2.3 | 5.1 |
| TMC: 0.1 wt % | | (Lm⁻²h⁻¹bar⁻¹) | | | | | | | | |
| IP time: 5 s; | | Salt rejection | — | 90.65 ± | 5.8 ± | 11.3 ± | 94.2 ± | 6.4 ± | 65.7 ± | 9.4 ± |
| Hexane | | (%) | | 1.50 | 0.3 | 0.6 | 1.6 | 0.6 | 3.7 | 1.8 |
| PIP: 0.1 wt %; | PES | Water | 24.9 ± | 16.9 ± | 19.4 ± | 25.6 ± | 18.3 ± | 18.9 ± | 20.0 ± | 24.8 ± |
| SLS: 1 mM | | permeance | 0.9 | 1.0 | 0.3 | 1.5 | 1.1 | 0.3 | 1.0 | 1.0 |
| TMC: 0.1 wt % | | (Lm⁻²h⁻¹bar⁻¹) | | | | | | | | |
| IP time: 5 s; | | Salt rejection | — | 98.53 ± | 49.2 ± | 20.4 ± | 99.0 ± | 62.0 ± | 97.1 ± | 21.5 ± |
| Hexane | | (%) | | 0.46 | 11.7 | 1.6 | 0.4 | 12.9 | 1.4 | 1.3 |

TABLE 8
Table 8. Performance of the freestanding membranes prepared via interfacial polymerization at the
aqueous-organic interface and then transferred on HPAN support. Membranes were tested under 5 bar operating
pressure at 25 (±1)° C. and 2 gL⁻¹ feed with a cross-flow velocity of 50 Lh⁻¹.

| Preparation conditions | Nanofiltration performance | | | | | | | | |
|---|---|---|---|---|---|---|---|---|---|
| of the nanofilm | | Pure | | | | | | | |
| composite membranes | Feed [symbol] | water | Na₂SO₄ | MgCl₂ | NaCl | K₂SO₄ | CaCl₂ | MgSO₄ | KCl |
| PIP: 0.02 wt %; | Water | 29.4 ± | 24.6 ± | 29.9 ± | 33.3 ± | — | 27.9 ± | 27.6 ± | 34.5 ± |
| SAR: 0 mM | permeance | 0.4 | 1.0 | 0.5 | 0.9 | | 0.5 | 0.6 | 0.9 |
| TMC: 0.15 wt % | (Lm⁻²h⁻¹bar⁻¹) | | | | | | | | |
| IP time: 10 s; | Salt rejection | | 91.3 ± | 4.4 ± | 9.8 ± | — | 3.8 ± | 72.8 ± | 13.7 ± |
| Hexane | (%) | | 0.1 | 1.6 | 0.3 | | 0.3 | 0.6 | 0.1 |
| PIP: 0.05 wt %; | Water | 27.2 ± | 21.8 ± | 28.7 ± | 30.4 ± | — | 26.1 ± | 24.9 ± | 31.2 ± |
| SAR: 0 mM | permeance | 0.8 | 0.8 | 0.3 | 1.1 | | 0.7 | 0.8 | 1.1 |
| TMC: 0.15 wt % | (Lm⁻²h⁻¹bar⁻¹) | | | | | | | | |
| IP time: 10 s; | Salt rejection | — | 94.0 ± | 9.4 ± | 14.8 ± | — | 8.1 ± | 85.1 ± | 34.3 ± |
| Hexane | (%) | | 0.4 | 0.9 | 0.8 | | 1.6 | 1.5 | 1.2 |
| PIP: 0.1 wt %; | Water | 20.3 ± | 14.9 ± | — | 20.7 ± | — | — | 13.7 ± | — |
| SAR: 0 mM | permeance | 3.8 | 2.0 | | 3.1 | | | 1.8 | |
| TMC: 0.15 wt % | (Lm⁻²h⁻¹bar⁻¹) | | | | | | | | |
| IP time: 10 s; | Salt rejection | — | 97.5 ± | — | 27.1 ± | — | — | 90.6 ± | — |
| Hexane | (%) | | 0.1 | | 0.7 | | | 0.1 | |
| PIP: 1.0 wt %; | Water | 13.9 ± | 10.7 ± | — | 12.7 ± | — | — | 10.2 ± | — |
| SAR: 0 mM | permeance | 2.5 | 1.7 | | 2.2 | | | 1.6 | |
| TMC: 0.15 wt % | (Lm⁻²h⁻¹bar⁻¹) | | | | | | | | |
| IP time: 10 s; | Salt rejection | — | 95.9 ± | — | 31.8 ± | — | — | 96.0 ± | — |
| Hexane | (%) | | 2.7 | | 1.1 | | | 3.1 | |
| PIP: 1.0 wt %; | Water | 7.5 ± | 7.5 ± | 6.3 ± | 7.0 ± | — | 6.7 ± | 7.6 ± | 6.9 ± |
| SLS: 1 mM | permeance | 0.3 | 0.3 | 0.3 | 0.4 | | 0.4 | 0.5 | 0.2 |
| pH = 9.2 | (Lm⁻²h⁻¹bar⁻¹) | | | | | | | | |
| TMC: 0.15 wt % | Salt rejection | — | 54.8 ± | 92.4 ± | 41.6 ± | — | 91.8 ± | 91.6 ± | 39.9 ± |
| IP time: 10 s; | (%) | | 4.2 | 1.0 | 3.1 | | 2.0 | 1.3 | 3.0 |
| Hexane | | | | | | | | | |
| PIP: 1.0 wt %; | Water | 4.7 ± | 4.9 ± | 3.9 ± | 4.7 ± | — | 4.1 ± | 4.7 ± | 4.4 ± |
| SLS: 1 mM | permeance | 0.1 | 0.1 | 0.1 | 0.1 | | 0.1 | 0.1 | 0.1 |
| pH = 9.6 | (Lm⁻²h⁻¹bar⁻¹) | | | | | | | | |
| TMC: 0.15 wt % | Salt rejection | — | 42.0 ± | 89.6 ± | 41.5 ± | — | 96.1 ± | 86.7 ± | 39.0 ± |
| IP time: 10 s; | (%) | | 2.8 | 1.3 | 0.7 | | 0.7 | 1.6 | 0.6 |
| Hexane | | | | | | | | | |

TABLE 9
Pure water permeance, rejection (%) of Na₂SO₄ and NaCl and ideal selectivity
between NaCl to Na₂SO₄. Concentration of salt used in the feed was 2 gL⁻¹. Membranes were
tested under 5 bar applied pressure with a cross-flow velocity of 50 Lh⁻¹ at 25 (±1) ° C.
Table 9

| Polymer nanofilms | | | | |
|---|---|---|---|---|
| (amine wt %-surface active reagent | | Na₂SO₄ | NaCl | Single salt |
| (SAR)/TMC wt % in organic phase-IP | PWP | Rejection | Rejection | selectivity* |
| time) | (LMH bar) | (%) | (%) | (NaCl/Na₂SO₄) |
| PIP 0.05%-SAR 0 mM/TMC 0.05%-hex-5 s | 47.9 ± 5.0 | 98.47 ± 0.76 | 14.2 ± 3.8 | 56.1 |
| PIP 0.05%-SAR 0 mM/TMC 0.1%-hex-5 s | 57.1 ± 1.9 | 98.32 ± 0.19 | 15.3 ± 0.8 | 50.4 |
| PIP 0.05%-SAR 0 mM/TMC 0.15%-hex-5 s | 59.6 ± 2.5 | 91.77 ± 1.24 | 8.9 ± 0.5 | 11.0 |
| PIP 0.1%-SAR 0 mM/TMC 0.05%-hex-5 s | 30.6 ± 1.0 | 98.30 ± 0.48 | 18.6 ± 1.0 | 47.9 |
| PIP 0.1%-SAR 0 mM/TMC 0.1%-hex-5 s | 37.6 ± 1.9 | 98.94 ± 0.37 | 16.2 ± 3.6 | 79.1 |
| PIP 0.1%-SAR 0 mM/TMC 0.15%-hex-5 s | 30.6 ± 3.3 | 97.37 ± 1.15 | 17.1 ± 1.5 | 31.5 |
| PIP 1.0%-SAR 0 mM/TMC 0.05%-hex-5 s | 24.7 ± 1.6 | 99.59 ± 0.21 | 26.7 ± 0.5 | 178.8 |
| PIP 1.0%-SAR 0 mM/TMC 0.1%-hex-5 s | 19.3 ± 1.4 | 99.65 ± 0.19 | 37.9 ± 2.9 | 177.4 |
| PIP 1.0%-SAR 0 mM/TMC 0.15%-hex-5 s | 15.9 ± 2.5 | 99.63 ± 0.20 | 30.1 ± 2.2 | 188.9 |
| PIP 2.0%-SAR 0 mM/TMC 0.05%-hex-5 s | 17.6 ± 0.9 | 98.65 ± 0.38 | 38.4 ± 1.1 | 45.6 |
| PIP 2.0%-SAR 0 mM/TMC 0.1%-hex-5 s | 18.6 ± 1.7 | 98.60 ± 0.70 | 24.2 ± 1.6 | 54.1 |
| PIP 2.0%-SAR 0 mM/TMC 0.15%-hex-5 s | 14.7 ± 1.4 | 98.75 ± 0.71 | 47.9 ± 4.9 | 41.7 |
| PIP 0.01%-SLS 1 mM/TMC 0.1%-hex-5 s | 59.0 ± 2.4 | 98.18 ± 0.42 | 9.7 ± 1.5 | 49.6 |
| PIP 0.01%-SLS 1 mM/TMC 0.15%-hex-5 s | 58.8 ± 5.4 | 96.78 ± 0.39 | 10.3 ± 1.5 | 27.9 |
| PIP 0.05%-SLS 1 mM/TMC 0.05%-hex-5 s | 22.6 ± 1.8 | 99.92 ± 0.08 | 41.1 ± 5.4 | 736.3 |
| PIP 0.05%-SLS 0.5 mM/TMC 0.1%-hex-5 s | 25.5 ± 0.4 | 99.87 ± 0.03 | 39.7 ± 1.15 | 463.8 |
| PIP 0.05%-SLS 1 mM/TMC 0.1%-hex-5 s | 23.1 ± 1.7 | 99.95 ± 0.03 | 45.0 ± 0.3 | 1100.0 |
| PIP 0.05%-SLS 2 mM/TMC 0.1%-hex-5 s | 17.7 ± 0.6 | 91.43 ± 5.33 | 18.2 ± 1.6 | 9.54 |
| PIP 0.05%-SLS 1 mM/TMC 0.15%-hex-5 s | 22.2 ± 1.7 | 99.95 ± 0.03 | 40.1 ± 0.3 | 1198 |
| PIP 0.1%-SLS 1 mM/TMC 0.05%-hex-5 s | 14.2 ± 0.8 | 99.81 ± 0.09 | 43.7 ± 4.9 | 296.3 |
| PIP 0.1%-SLS 1 mM/TMC 0.1%-hex-5 s | 16.4 ± 1.1 | 99.96 ± 0.03 | 42.1 ± 1.8 | 1447.5 |
| PIP 0.1%-SLS 1 mM/TMC 0.1%-hex-30 s | 15.1 ± 0.2 | 99.98 ± 0.01 | 42.9 ± 1.0 | 2855.0 |
| PIP 0.1%-SLS 1 mM/TMC 0.1%-hex-2 min | 11.9 ± 0.6 | 99.98 ± 0.01 | 51.0 ± 0.9 | 2448.0 |
| PIP 0.1%-SLS 1 mM/TMC 0.1%-hex-20 min | 8.1 ± 0.3 | 99.99 ± 0.01 | 56.9 ± 0.9 | 4310.0 |
| PIP 0.1%-SLS 1 mM/TMC 0.1%-hex-5 s-PAN | 14.1 ± 0.7 | 99.70 ± 0.02 | 42.8 ± 1.1 | 190.7 |
| PIP 0.1%-SLS 1 mM/TMC 0.1%-hex-5 s-P84 | 45.6 ± 4.2 | 90.65 ± 1.50 | 11.3 ± 0.6 | 9.5 |
| PIP 0.1%-SLS 1 mM/TMC 0.1%-hex-5 s-PES | 24.9 ± 0.9 | 98.53 ± 0.46 | 20.4 ± 1.6 | 54.1 |
| PIP 0.1%-SLS 1 mM/TMC 0.1%-hep-5 s | 13.3 ± 1.1 | 99.78 ± 0.02 | 41.5 ± 2.0 | 265.9 |
| PIP 0.1%-SLS 1 mM/TMC 0.1%-clh-5 s | 13.8 ± 0.5 | 99.79 ± 0.01 | 43.8 ± 1.7 | 267.6 |
| PIP 0.1%-SLS 1 mM/TMC 0.15%-hex-5 s | 16.2 ± 1.5 | 99.91 ± 0.09 | 44.6 ± 1.65 | 615.5 |
| PIP 1.0%-SLS 1 mM/TMC 0.15%-hex-5 s | 6.1 ± 0.9 | 91.73 ± 6.06 | 61.2 ± 2.8 | 4.7 |
| Commercial nanofiltration membrane Dow | 22.2 ± 1.5 | 99.56 ± 0.10 | 51.5 ± 2.2 | 110.2 |
| FILMTEC™ NF270 (tested in our laboratory) | | | | |

TABLE 10
Pure water permeance, rejection (%) of MgCl₂ and NaCl and ideal selectivity
between NaCl to MgCl₂. Membranes were tested under 5 bar applied pressure with a cross-
flow velocity of 50 Lh⁻¹ at 25 (±1) ° C.
Table 10

| Polymer nanofilms | PWP | MgCl₂ | NaCl | Single salt |
|---|---|---|---|---|
| (amine wt %-surface active reagent | (LMH | Rejection | Rejection | selectivity* |
| (SAR)/TMC wt % in organic phase-IP time) | bar) | (%) | (%) | (NaCl/MgCl₂) |
| PIP 1.0%-SAR 0 mM/TMC 0.05%-hex-5 s | 24.7 ± 1.6 | 80.5 ± 4.0 | 26.7 ± 0.5 | 3.8 |
| PIP 1.0%-SAR 0 mM/TMC 0.1%-hex-5 s | 19.3 ± 1.4 | 73.4 ± 2.5 | 37.9 ± 2.9 | 2.3 |
| PIP 2.0%-SAR 0 mM/TMC 0.05%-hex-5 s | 17.6 ± 0.9 | 96.9 ± 0.6 | 38.4 ± 1.1 | 19.9 |
| PIP 2.0%-SAR 0 mM/TMC 0.1%-hex-5 s | 18.6 ± 1.7 | 75.4 ± 1.9 | 24.2 ± 1.6 | 3.1 |
| PIP 2.0%-SAR 0 mM/TMC 0.15%-hex-5 s | 14.7 ± 1.4 | 65.5 ± 6.3 | 47.9 ± 4.9 | 1.5 |
| PIP 0.05%-SLS 1 mM/TMC 0.05%-hex-5 s | 22.6 ± 1.8 | 94.6 ± 0.7 | 41.1 ± 5.4 | 10.9 |
| PIP 0.05%-SLS 0.5 mM/TMC 0.1%-hex-5 s | 25.5 ± 0.4 | 88.9 ± 0.7 | 39.7 ± 1.15 | 5.4 |
| PIP 0.05%-SLS 1 mM/TMC 0.1%-hex-5 s | 23.1 ± 1.7 | 93.9 ± 2.7 | 45.0 ± 0.3 | 9.02 |
| PIP 0.05%-SLS 2 mM/TMC 0.1%-hex-5 s | 17.7 ± 0.6 | 92.9 ± 0.6 | 18.2 ± 1.6 | 11.5 |
| PIP 0.05%-SLS 5 mM/TMC 0.1%-hex-5 s | 16.9 ± 1.1 | 85.7 ± 3.8 | 18.4 ± 1.4 | 5.7 |
| PIP 0.05%-SLS 10 mM/TMC 0.1%-hex-5 s | 22.8 ± 1.4 | 58.9 ± 9.7 | 10.2 ± 0.3 | 2.2 |
| PIP 0.05%-SLS 1 mM/TMC 0.15%-hex-5 s | 22.2 ± 1.7 | 79.1 ± 0.8 | 40.1 ± 0.3 | 2.9 |
| PIP 0.1%-SLS 1 mM/TMC 0.05%-hex-5 s | 14.2 ± 0.8 | 98.4 ± 0.3 | 43.7 ± 4.9 | 35.3 |
| PIP 0.1%-SLS 1 mM/TMC 0.1%-hex-5 s | 16.4 ± 1.1 | 98.1 ± 0.1 | 42.1 ± 1.8 | 30.5 |
| PIP 0.1%-SLS 1 mM/TMC 0.1%-hex-30 s | 15.1 ± 0.2 | 97.8 ± 0.3 | 42.9 ± 1.0 | 26.0 |
| PIP 0.1%-SLS 1 mM/TMC 0.1%-hex-2 min | 11.9 ± 0.6 | 98.2 ± 0.1 | 51.0 ± 0.9 | 27.5 |
| PIP 0.1%-SLS 1 mM/TMC 0.1%-hex-20 min | 8.1 ± 0.3 | 98.0 ± 0.1 | 56.9 ± 0.9 | 21.6 |
| PIP 0.1%-SLS 1 mM/TMC 0.1%-hex-5 s-PAN | 14.1 ± 0.7 | 93.1 ± 2.2 | 42.8 ± 1.1 | 8.3 |
| PIP 0.1%-SLS 1 mM/TMC 0.1%-hep-5 s | 13.3 ± 1.1 | 97.7 ± 0.3 | 41.5 ± 2.0 | 25.4 |
| PIP 0.1%-SLS 1 mM/TMC 0.1%-tol-5 s | 15.3 ± 1.4 | 89.4 ± 1.0 | 30.9 ± 1.2 | 6.5 |
| PIP 0.1%-SLS 1 mM/TMC 0.1%-clh-5 s | 13.8 ± 0.5 | 97.6 ± 0.1 | 43.8 ± 1.7 | 23.4 |
| PIP 0.1%-SLS 1 mM/TMC 0.15%-hex-5 s | 16.2 ± 1.5 | 96.7 ± 0.6 | 44.6 ± 1.65 | 16.8 |
| PIP 1.0%-SLS 1 mM/TMC 0.05%-hex-5 s | 13.7 ± 4.4 | 89.5 ± 7.1 | 30.7 ± 7.3 | 6.6 |
| PIP 1.0%-SLS 1 mM/TMC 0.1%-hex-5 s | 7.4 ± 1.0 | 96.3 ± 0.9 | 48.5 ± 1.8 | 13.9 |
| PIP 1.0%-SLS 1 mM/TMC 0.15%-hex-5 s | 6.1 ± 0.9 | 99.0 ± 0.1 | 61.2 ± 2.8 | 38.8 |
| PIP 2.0%-SLS 1 mM/TMC 0.15%-hex-5 s | 4.4 ± 0.6 | 98.4 ± 0.1 | 54.5 ± 0.6 | 28.4 |

### Example 18

Performance of Nanofilm Composite Membranes with Increasing Feed Salt Concentration:

Nanofiltration performance of the nanofilm composite membranes in terms of salt rejection with increasing salt concentration in the feed solution is presented in FIG. 7. Salt concentration was varied from 0.5-40 gL⁻¹. Measurements were done under 5 bar (for salt concentration of 0.5-8 gL⁻¹), 10 bar (for salt concentration of 20 gL⁻¹) and 20 bar (for salt concentration of 40 gL⁻¹) at a cross-flow velocity of 50 Lh⁻¹ at 25 (±1) ° C.

### Example 19

Membrane Performance at Different Concentration of Sodium Lauryl Sulphate Used in the Aqueous Phase During Interfacial Polymerization:

Membrane performance was studied in terms of pure water permeance, salt rejection and salt selectivity. Membranes were made at different concentration of sodium lauryl sulphate added in the aqueous phase during interfacial polymerization wherein the preferred polymerization time was 5 s. Polymerization reaction time was also varied from 5 s to 20 min to study the separation performance of the membranes. Results are presented in Table 6.

### Example 20

Fluoride Rejection of the Nanofilm Composite Membranes:

Nanofiltration performance of the membranes with sodium fluoride feed was evaluated and the results are presented in Table 11.

TABLE 11
Table 11. Fluoride separation performance of the nanofilm composite membranes.
Measurements were done under 5 bar applied pressure with a cross-flow velocity
of 50 Lh⁻¹ at 25 (±1)° C. and a salt concentration of 2 gL⁻¹.

| | PIP 0.05%-SAR | | PIP 0.05%-SLS | | PIP 0.1%-SAR | | PIP 0.1%-SLS | |
|---|---|---|---|---|---|---|---|---|
| | 0 mM/TMC | | 1 mM/TMC | | 0 mM/TMC | | 1 mM/TMC | |
| | 0.1%-hex-5 s | | 0.1%-hex- 5 s | | 0.1%-hex-5 s | | 0.1%-hex-5 s | |
| | Water | Salt | Water | Salt | Water | Salt | Water | Salt |
| Pure | permeance | rejection | permeance | rejection | permeance | rejection | permeance | rejection |
| water/Salt | (LMHbar) | (%) | (LMHbar) | (%) | (LMHbar) | (%) | (LMHbar) | (%) |
| Pure | 57.1 ± | — | 23.1 ± | — | 37.6 ± | — | 16.4 ± | — |
| water | 1.9 | | 1.7 | | 1.9 | | 1.1 | |
| NaF | 58.2 ± | 45.0 ± | 22.8 ± | 86.8 ± | 34.2 ± | 60.4 ± | 16.1 ± | 84.6 ± |
| | 1.9 | 6.9 | 1.0 | 0.6 | 0.7 | 2.4 | 0.4 | 0.9 |

Permeance values are expressed as liters m⁻²hour⁻¹bar⁻¹ (LMH bar)

### Example 21

Nanofiltration Performance and Ion Selectivity by Using Mixed Salts where Two Salts are Used in the Feed

Nanofiltration performance and ion selectivity by using mixed salts where two salts are used as feed. Results are summarized in Table 12.

### Example 22

Nanofiltration Performance and Ion Selectivity by Using Mixed Salts where Four Salts are Used in the Feed:

Nanofiltration performance and ion selectivity by using mixed salts where four salts are used as feed. Results are summarized in Table 13.

TABLE 12
Table 12. Comparison of ion selectivity between single salt and mixed salt at different salt concentrations.
Nanofiltration performance of the single salt and mixed salts from low to high concentrations where two salts (Na₂
SO₄ and NaCl) were used as mixed salt with equal concentration (1:1 in wt %). Membranes were tested at 25 (±1)°
C. and a cross-flow velocity of 50 Lh⁻¹ under different pressure to overcome the osmotic pressure.

| | | Membrane | | Membrane | | | Membrane | | | |
|---|---|---|---|---|---|---|---|---|---|---|
| | | performance with | | performance with | | | performance in | | | |
| Nanofilm | Pure | pure Na₂SO₄ feed | | pure NaCl feed | | Single salt | mixed salt* | | | Mixed ion |
| composite & | water | Water | | Water | | selectivity | Water | Rejection | Rejection | selectivity |
| commercial | permeance | permeance | Rejection | permeance | Rejection | (NaCl | permeanee | of SO₄²⁻ | of Cl⁻ | (Cl⁻ to |
| membranes | (LMHbar) | (LMHbar) | (%) | (LMHbar) | (%) | to Na₂SO₄ | (LMHbar) | (%) | (%) | SO₄²⁻) |

Total salt: 2 gL⁻¹; Applied pressure: 5 bar

| | | | | | | | | | | |
|---|---|---|---|---|---|---|---|---|---|---|
| Mem #1 | 16.4 ± | 12.4 ± | 99.96 ± | 13.7 ± | 42.1 ± | 1447 | 13.9 ± | 99.95 ± | 39.1 ± | 1217 |
| | 1.1 | 0.8 | 0.03 | 1.0 | 1.8 | | 1.1 | 0.01 | 2.9 | |
| Mem #2 | 19.3 ± | 12.5 ± | 99.65 ± | 17.0 ± | 37.9 ± | 179 | 18.7 ± | 99.93 ± | 36.4 ± | 909 |
| | 1.4 | 1.8 | 0.19 | 1.1 | 2.9 | | 0.5 | 0.03 | 0.95 | |
| Mem #3 | 37.6 ± | 21.1 ± | 98.94 ± | 35.6 ± | 16.2 ± | 79.1 | 32.4 ± | 99.30 ± | 5.9 ± | 135 |
| | 1.9 | 0.6 | 0.37 | 1.9 | 3.6 | | 0.3 | 0.33 | 0.3 | |
| NF270 | 22.2 ± | 15.5 ± | 99.56 ± | 17.8 ± | 51.5 ± | 110 | | | | |
| | 1.5 | 1.7 | 0.10 | 1.4 | 2.2 | | | | | |

Total salt: 8 gL⁻¹; Applied pressure: 5 bar

| | | | | | | | | | | |
|---|---|---|---|---|---|---|---|---|---|---|
| Mem #1 | 16.4 ± | 5.3 ± | 99.78 ± | 11.5 ± | 24.6 ± | 339 | 9.8 ± | 99.94 ± | 12.4 ± | 1460 |
| | 1.1 | 0.6 | 0.06 | 0.7 | 0.8 | | 0.8 | 0.02 | 5.2 | |
| Mem #2 | 19.3 ± | 6.7 ± | 99.30 ± | 18.3 ± | 15.6 ± | 131 | 13.5 ± | 99.81 ± | 0.9 ± | 522 |
| | 1.4 | 0.3 | 0.10 | 1.2 | 0.9 | | 0.4 | 0.05 | 3.7 | |
| Mem #3 | 37.6 ± | 8.5 ± | 93.99 ± | 38.4 ± | 7.1 ± | 15.4 | 24.2 ± | 97.63 ± | −12.5 ± | 46.5 |
| | 1.9 | 0.02 | 1.90 | 0.5 | 0.4 | | 0.3 | 1.01 | 1.8 | |

Total salt: 20 gL⁻¹; Applied pressure: 20 bar

| | | | | | | | | | | |
|---|---|---|---|---|---|---|---|---|---|---|
| Mem #1 | 12.9 ± | 3.1 ± | 99.51 ± | 8.5 ± | 22.1 ± | 159 | 7.5 ± | 99.91 ± | 11.5 ± | 983 |
| | 0.5 | 0.8 | 0.11 | 0.4 | 1.8 | | 0.3 | 0.01 | 8.2 | |
| Mem #2 | 15.1 ± | 3.2 ± | 93.40 ± | 11.2 ± | 12.3 ± | 13.4 | 7.4 ± | 99.43 ± | 2.9 ± | 170 |
| | 1.0 | 0.9 | 4.10 | 0.8 | 1.9 | | 0.1 | 0.37 | 1.3 | |
| Mem #3 | 25.1 ± | 5.4 ± | 84.41 ± | 21.9 ± | 2.8 ± | 6.2 | 9.8 ± | 94.04 ± | −9.6 ± | 18.4 |
| | 1.0 | 0.2 | 1.76 | 0.8 | 0.3 | | 0.1 | 1.55 | 8.2 | |

Total salt: 40 gL⁻¹; Applied pressure: 20 bar

| | | | | | | | | | | |
|---|---|---|---|---|---|---|---|---|---|---|
| Mem #1 | 12.9 ± | 1.5 ± | 98.59 ± | 6.8 ± | 17.0 ± | 58.8 | 5.2 ± | 99.78 ± | −4.8 ± | 476 |
| | 0.5 | 0.1 | 0.75 | 0.4 | 1.0 | | 0.3 | 0.02 | 2.1 | |
| Mem #2 | 15.1 ± | 1.6 ± | 92.69 ± | 9.8 ± | 8.5 ± | 12.5 | 5.3 ± | 99.34 ± | −6.9 ± | 162 |
| | 1.0 | 0.1 | 3.98 | 0.6 | 0.8 | | 0.1 | 0.32 | 0.73 | |
| Mem #3 | 25.1 ± | 2.7 ± | 73.51 ± | 17.8 ± | 3.0 ± | 3.7 | 7.2 ± | 91.26 ± | −15.9 ± | 13.3 |
| | 1.0 | 0.03 | 1.99 | 0.9 | 0.3 | | 0.1 | 1.95 | 1.6 | |

Mem #1: PIP 0.1%-SLS 1 mM/TMC 0.1%-hex-5 s;
Mem #2: PIP 1.0%-SAR 0 mM/TMC 0.1%-hex-5 s;
Mem #3: PIP 0.1%-SAR 0 mM/TMC 0.1%-hex-5 s;
NF270: Commercial nanofiltration membrane from Dow FILMTEC ™ (tested in our laboratory)
*Two salts (NaCl and Na₂SO₄) are in equal wt %. Permeance values are expressed as liters in m⁻²hour⁻¹bar⁻¹ (LMH bar)

TABLE 13
Nanofiltration performances at high salt concentration where four salts (Na₂SO₄,
MgSO₄, MgCl₂ and NaCl) were used as mixed salt feed. Four salts were used in equal wt % in feed
solution. Membranes were tested under different pressure greater than the osmotic pressure at 25
(±1) ° C. and a cross-flow velocity of 50 Lh⁻¹.
Table 13

| | | Membrane performance in | | | |
|---|---|---|---|---|---|
| | | mixed salt* | | | |
| | | | Rejection | | Mixed ion |
| | Pure water | Water | of | Rejection | selectivity |
| Membrane | permeance | permeance | SO₄²⁻ | of Cl⁻ | (Cl⁻ to |
| Types | (LMH bar) | (LMH bar) | (%) | (%) | SO₄²⁻) |

Total salt: 2 gL⁻¹; Applied pressure: 5 bar

| | | | | | |
|---|---|---|---|---|---|
| PIP 0.1%-SLS 1 mM/TMC 0.1%-hex-5 s | 16.4 ± 1.1 | 13.6 ± 1.1 | 99.94 | 48.5 | 858.3 |
| PIP 1.0%-SAR 0 mM/TMC 0.1%-hex-5 s | 19.3 ± 1.4 | 17.0 ± 0.6 | 99.81 | 23.3 | 403.7 |
| PIP 0.1%-SAR 0 mM/TMC 0.1%-hex-5 s | 37.6 ± 1.9 | 28.3 ± 0.8 | 95.67 | −8.5 | 25.1 |
| NF270 | 22.2 ± 1.5 | 17.5 ± 1.5 | 99.42 | 33.1 | 115.3 |

Total salt: 8 gL⁻¹; Applied pressure: 5 bar

| | | | | | |
|---|---|---|---|---|---|
| PIP 0.1%-SLS 1 mM/TMC 0.1%-hex-5 s | 16.4 ± 1.1 | 9.1 ± 0.8 | 99.94 | 37.3 | 1045.0 |
| PIP 1.0%-SAR 0 mM/TMC 0.1%-hex-5 s | 19.3 ± 1.4 | 12.2 ± 0.4 | 99.72 | 19.4 | 287.8 |
| PIP 0.1%-SAR 0 mM/TMC 0.1%-hex-5 s | 37.6 ± 1.9 | 21.9 ± 0.6 | 93.50 | −5.8 | 16.3 |
| NF270 | 22.2 ± 1.5 | 10.9 ± 1.7 | 99.36 | 29.8 | 109.6 |

Total salt: 20 gL⁻¹; Applied pressure: 20 bar

| | | | | | |
|---|---|---|---|---|---|
| PIP 0.1%-SLS 1 mM/TMC 0.1%-hex-5 s | 12.9 ± 0.5 | 6.3 ± 0.3 | 99.89 | 35.1 | 590.0 |
| PIP 1.0%-SAR 0 mM/TMC 0.1%-hex-5 s | 15.1 ± 1.0 | 6.3 ± 0.1 | 99.04 | 22.0 | 81.2 |
| PIP 0.1%-SAR 0 mM/TMC 0.1%-hex-5 s | 25.1 ± 1.0 | 8.6 ± 0.1 | 93.30 | −11.5 | 16.6 |
| NF270 | 16.8 ± 2.9 | 6.5 ± 1.0 | 99.60 | 38.4 | 154.0 |

Total salt: 40 gL⁻¹; Applied pressure: 20 bar

| | | | | | |
|---|---|---|---|---|---|
| PIP 0.1%-SLS 1 mM/TMC 0.1%-hex-5 s | 12.9 ± 0.5 | 4.0 ± 0.2 | 99.89 | 30.0 | 636.4 |
| PIP 1.0%-SAR 0 mM/TMC 0.1%-hex-5 s | 15.1 ± 1.0 | 4.1 ± 0.1 | 98.97 | 16.5 | 81.1 |
| PIP 0.1%-SAR 0 mM/TMC 0.1%-hex-5 s | 25.1 ± 1.0 | 6.0 ± 0.1 | 93.30 | −7.5 | 16.0 |
| NF270 | 16.8 ± 2.9 | 3.6 ± 0.6 | 99.44 | 32.6 | 120.3 |

Permeance values are expressed as liters m⁻²hour⁻¹bar⁻¹ (LMH bar). NF270: Commercial nanofiltration membrane from Dow FILMTEC ™ NF270 (tested in our laboratory).

### Example 23

Separation of Charged and Uncharged Molecules and the MWCO of Different Polyamide Nanofilm Composite Membranes:

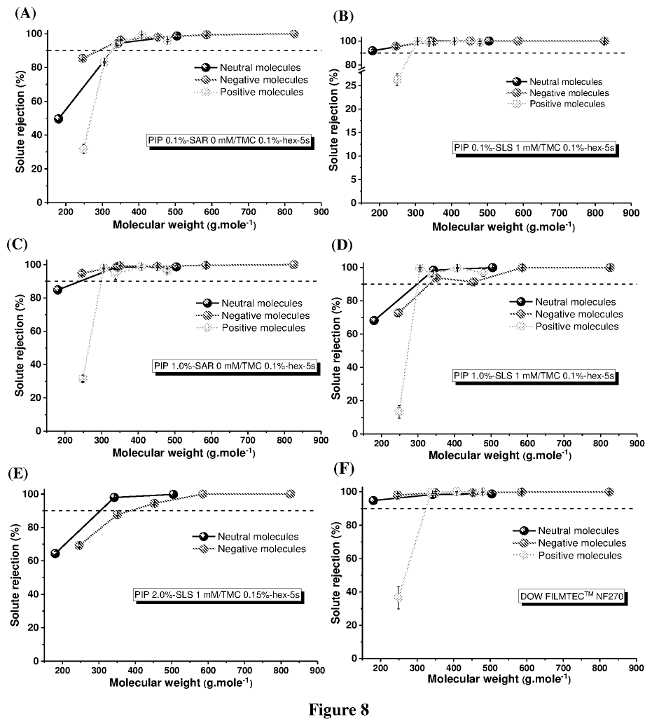

Separation of charged and uncharged molecules and MWCO of different polyamide membranes was measured. Results are presented in Table 14 and FIG. 8, respectively.

TABLE 14
Table 14. Permeance and rejection of the polyamide nanofilm composite membranes fabricated
on HPAN support for different carbohydrates and dyes. Used feed concentration of carbohydrates and dyes
are 1 gL⁻¹ and 200 mgL⁻¹, respectively. Rejection of carbohydrates were calculated from
HPLC measurement and rejection of dyes were calculated from the UV-Vis absorbance.

| | Polyamide nanofilm composite membranes prepared on HPAN support | | | | | | | | | |
|---|---|---|---|---|---|---|---|---|---|---|
| | PIP 0.1%-SAR | | PIP 1.0%-SAR | | PIP 0.1%-SLS | | PIP1.0%-SLS | | PIP 2.0%-SLS | |
| | 0 mM/TMC | | 0 mM/TMC | | 1 mM/TMC | | 1 mM/TMC | | 1 mM/TMC | |
| | 0.1%-hex-5 s | | 0.1%-hex-5 s | | 0.1%-hex-5 s | | 0.1%-hex-5 s | | 0.15%-hex-5 s | |
| | | Rejection | | Rejection | | Rejection | | Rejection | | Rejection |
| Carbohydrates/dyes | WP* | (%) | WP* | (%) | WP* | (%) | WP* | (%) | WP* | (%) |
| Glucose | 28.8 ± | 49.6 ± | 19.4 ± | 84.8 ± | 15.4 ± | 91.9 ± | 6.1 ± | 68.2 ± | 4.6 ± | 64.4 ± |
| (MW = 180.2) | 0.9 | 2.5 | 1.6 | 2.6 | 1.7 | 1.0 | 0.4 | 1.7 | 0.6 | 1.4 |
| Sucrose | 28.4 ± | 94.4 ± | 18.8 ± | 98.7 ± | 15.3 ± | ≥99.9 | 5.8 ± | 98.4 ± | 4.4 ± | 97.9 ± |
| (MW = 342.3) | 0.9 | 1.3 | 1.4 | 1.4 | 1.5 | | 0.3 | 0.3 | 0.7 | 0.1 |
| Raffinose | 28.9 ± | 98.7 ± | 19.2 ± | 98.6 ± | 15.8 ± | ≥99.9 | 5.9 ± | ≥99.9 | 4.4 ± | 99.8 ± |
| (MW = 504.4) | 0.6 | 0.6 | 1.6 | 1.0 | 1.5 | | 0.4 | | 0.6 | 0.1 |
| HNSA | 26.2 ± | 85.5 ± | 18.0 ± | 94.8 ± | 15.4 ± | 95.7 ± | 3.7 ± | 72.7 ± | 2.7 ± | 69.2 ± |
| (MW = 246.2) | 0.5 | 0.7 | 1.5 | 1.1 | 1.3 | 1.0 | 0.3 | 1.9 | 0.2 | 0.9 |
| Acid Orange 7 | 27.6 ± | 96.4 ± | 18.1 ± | 99.4 ± | 15.0 ± | 99.5 ± | 2.4 ± | 93.8 ± | 1.9 ± | 87.6 ± |
| (MW = 350.3) | 0.6 | 0.2 | 1.4 | 0.1 | 1.3 | 0.1 | 0.2 | 0.4 | 0.2 | 0.4 |
| Orange G | 31.5 ± | 98.0 ± | 19.3 ± | 98.9 ± | 15.3 ± | ≥99.9 | 3.9 ± | 91.3 ± | 2.6 ± | 94.4 ± |
| (MW = 452.4) | 0.5 | 0.5 | 1.8 | 0.4 | 1.5 | | 0.3 | 1.2 | 0.4 | 0.4 |
| Acid Fuchsin | 25.5 ± | 99.4 ± | 18.6 ± | 99.6 ± | 15.5 ± | ≥99.9 | 4.6 ± | ≥99.9 | 3.3 ± | ≥99.9 |
| (MW = 585.5) | 0.3 | 0.3 | 1.6 | 0.2 | 1.5 | | 0.3 | | 0.4 | |
| Brilliant blue R | 18.3 ± | ≥99.9 | 16.5 ± | ≥99.9 | 16.4 ± | ≥99.9 | 3.6 ± | ≥99.9 | 3.4 ± | ≥99.9 |
| (MW = 825.9) | 0.2 | | 1.3 | | 1.0 | | 0.3 | | 0.4 | |
| Crysodine G | 19.9 ± | 31.8 ± | 19.2 ± | 31.5 ± | 9.1 ± | 26.2 ± | 5.6 ± | 13.4 ± | 3.6 ± | 6.8 ± |
| (MW = 248.7) | 1.2 | 2.9 | 0.7 | 1.8 | 0.9 | 1.3 | 0.3 | 3.8 | 0.5 | 8.3 |
| Toluidine blue O | 20.2 ± | 83.3 ± | 16.6 ± | 97.8 ± | 10.8 ± | 99.87 ± | 6.2 ± | 99.5 ± | — | — |
| (MW = 305.8) | 2.2 | 0.5 | 0.5 | 0.4 | 1.0 | 0.03 | 0.4 | 0.5 | | |
| Basic Fuchsin | 15.1 ± | 94.0 ± | 10.3 ± | 94.3 ± | 6.2 ± | 98.6 ± | 6.0 ± | 96.1 ± | 3.5 ± | 96.9 ± |
| (MW = 337.9) | 0.8 | 0.1 | 0.8 | 3.3 | 0.9 | 0.7 | 0.4 | 1.4 | 0.4 | 0.8 |
| Crystal Violet | 12.6 ± | 99.3 ± | 10.0 ± | 98.8 ± | 6.0 ± | 99.8 ± | 5.7 ± | 99.6 ± | 3.6 ± | ≥99.9 |
| (MW = 407.9) | 1.0 | 0.1 | 0.6 | 0.4 | 0.8 | 0.1 | 0.4 | 0.4 | 0.6 | |
| Rhodamine B | 21.2 ± | 96.1 ± | 18.8 ± | 96.4 ± | 11.8 ± | 98.9 ± | 7.9 ± | 96.9 ± | 5.0 ± | ≥99.9 |
| (MW = 479.0) | 0.8 | 0.4 | 0.9 | 1.1 | 1.2 | 0.7 | 0.3 | 2.2 | 0.6 | |

*WP = Water permeance measured with dissolved solutes expressed as Liter hour⁻¹meter⁻²bar⁻¹ (Lm⁻²h⁻¹bar⁻¹). MW = Molecular weight (g · mol⁻¹), HNSA = 2-Naphthol-6-sulfonic acid

### Example 24

Performance of the Polyamide Nanofilm Composite Membranes Under Different Pressure:

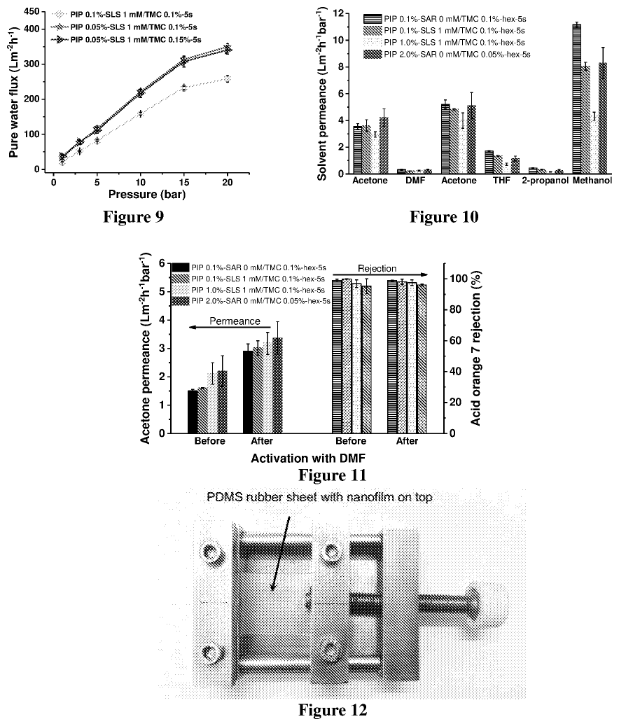

Performance of the nanofilm composite membranes under different pressure was measured and the results are presented in FIG. 9. Membranes were allowed to reach at the steady state at each applied pressure by pressurizing at the said pressure for a few hours.

### Example 25

Solvent Transport Through Polyamide Nanofilm Composite Membranes:

Solvent transport properties in terms of the pure solvent permeance through nanofilm composite membrane were studied. First, the acetone permeance was measured and then DMF permeance was recorded. The acetone permeance was recorded again to confirm the stability of the nanofilm composite membrane in DMF. An increased in acetone permeance (21 to 46%) was observed after the measurement of DMF permeance and the percentage increase is because of the swelling (e.g., an activation effect) of the polymer separation layer in DMF followed by the rearrangement in acetone (Karan et al., Science 348, 1347, 2015). Permeance of THF, 2-propanol and methanol was measured wherein the highest permeance was achieved for methanol. Results are presented in FIG. 10.

### Example 26

Solvent Permeance and Molecular Separation Study Before and After DMF Activation of the Nanofilm Composite Membranes:

Solvent permeance and molecular separation performance before and after DMF activation of the nanofilm composite membranes was studied. Results are presented in FIG. 11.

### Example 27

Wrinkling-Based Measurement of Young's Modulus of the Nanofilms:

The Young's modulus of the nanofilms was determined from the wrinkling based experiment. The fixture assembly used for this experiment is shown in FIG. 12. The front surface of the nanofilm is placed on the top of the PDMS. The measured Young's modulus values were in the range of 297-298 MPa.

### Example 28

Measurement of Mass and Density of the Nanofilms with Quartz Crystal Microbalance (QCM)

The dry masses of the nanofilms were measured in both the configurations; (i) the front surface of the nanofilm is on the top, and (ii) the rear surface of the nanofilm is on the top. The dry mass density was calculated from the change in frequency and the known thickness of the nanofilm, Table 15 (Karan et al., Science 348, 1347, 2015).

TABLE 15
Table 15: Dry mass density of the nanofilms measured with QCM.

| | IP conditions | | | | | | | |
|---|---|---|---|---|---|---|---|---|
| Polyamide nanofilms | PIP (wt %) in the aqueous phase | SLS (mM) in the aqueous phase | TMC (wt %) in the organic phase | IP time (s) | Frequency change Δf (Hz) | Thickness of the nanofilm h_{nf} (nm) | $\begin{matrix}Areal \\ mass \\ density of \\ the \\ nanofilm \\ \frac{m}{A} ( μg \cdot {cm}^{- 2} )\end{matrix}$ | Mass density of the nanofilm ρ (g · cm⁻³) |
| PIP-0.1%-SAR | 0.1 | 0.0 | 0.1 | 5 | 124 | 18.0 + 1.1 | 2.19 | 1.22 |
| 0 mM/TMC | | | | | | | | |
| 0.1%-5s^{#} | | | | | | | | |
| PIP-0.l%-SAR | 0.1 | 0.0 | 0.1 | 5 | 116 ± 10.5 | 18.0 + 1.1 | 2.06 | 1.14 |
| 0 mM/TMC | | | | | | | | |
| 0.1%-5s^{##} | | | | | | | | |
| PIP-0.l%-SLS | 0.1 | 1.0 | 0.1 | 5 | 143 ± 9.5 | 20.6 + 0.4 | 2.53 | 1.22 |
| 1 mM/TMC | | | | | | | | |
| 0.1%-5s^{#} | | | | | | | | |

(^{#}) the front surface of the nanofilm is on the top, and
(^{##}) the rear surface of the nanofilm is on the top.

### ADVANTAGES OF THE INVENTION

Highly selective ultrathin polymer nanofilm composite membrane has the following advantages:

1. Nanofilm composite membranes presented herein are made via interfacial polymerization which is commonly used for large scale industrial membrane production and used for desalination.

2. Nanofilm composite membranes presented herein are made with low cost surface active reagents.

3. Nanofilm composite membranes presented herein are stable in organic solvent when the nanofilm is made on a solvent stable base layer of porous polymer support membrane.

4. Nanofilm composite membranes presented herein have the unique features with tunable salt rejection properties, increased monovalent to multivalent ion selectivity and lower organic fouling.

5. Nanofilm composite membranes presented herein exhibit up to 99.99% rejection of divalent salt (Na₂SO₄) and demonstrate monovalent to divalent ion selectivity of more than 4000.

6. Nanofilm composite membranes presented herein exhibit the performance beyond the permeance-selectivity upper-bound line of the state-of-the-art nanofiltration membranes and one to two orders of magnitude higher than the commercially available membranes.

1-15. (canceled)

16-18. (not entered)

19. A highly selective ultrathin polymer nanofilm composite membrane comprising:
(a) a base layer of porous polymer support membrane; and
(b) an upper polymer nanofilm layer;
wherein:
the upper polymer nanofilm layer is made via interfacial polymerization in the presence of a surfactant at a concentration from 0.01 mM to 1 M in an aqueous phase; and
a thickness of the upper polymer nanofilm layer is from 7 nm to 150 nm; and
the upper polymer nanofilm layer has an elemental composition (atomic %) of 71.4% to 74.8% carbon, 7.5% to 12.8% nitrogen, and 12.4% to 21.1% oxygen.

20. The composite membrane of claim 19, wherein the upper polymer nanofilm layer is selected from the group consisting of polyamide, polyurea, polyurethane, polyester, polysulfonamide, polyphthalamide, polypyrrolidine, polysiloxane, poly(amide imide), poly(ether amide), poly(ester amide), and poly(urea amide).

21. The composite membrane of claim 19, wherein the composite membrane has a zeta potential value from −12.2 mV to −27.2 mV at pH 7.0.

22. The composite membrane of claim 19, wherein the composite membrane has a Young's modulus from 297 MPa to 298 MPa, a mass density from 1.14 g/cm³ to 1.22 g/cm³, and a water contact angle value of from 25.7° to 59.6°.

23. The composite membrane of claim 19, wherein the base layer of porous polymer support membrane is selected from the group consisting of hydrolyzed polyacrylonitrile (HPAN), polysulfone (PSf), polyethersulfone (PES), P84, crosslinked P84, and polyacrylonitrile (PAN).

24. The composite membrane of in claim 19, wherein the surface active agent is selected from the group consisting of an anionic surfactant, a cationic surfactant, a zwitterionic surfactant, and a neutral surfactant.

25. The composite membrane of claim 19, wherein the composite membrane has a pure water permeance from 8.1 Lm⁻²h⁻¹bar⁻¹ to 57.1 Lm⁻²h⁻¹bar⁻¹, a rejection of Na₂SO₄ from greater than 98.0% to 99.99%, and a rejection of NaCl from 15.3% to 56.9%.

26. The composite membrane of claim 19, wherein the composite membrane has an ideal salt selectivity between NaCl to Na₂SO₄ from greater than 1 to 4310.

27. The composite membrane of claim 19, wherein the composite membrane has a pure water permeance from of 6.1 Lm⁻²h⁻¹bar⁻¹ to 17.6 Lm⁻²h⁻¹bar⁻¹, a rejection of MgCl₂ from greater than 97.0% to 99.0%, and rejection of NaCl from 38.4% to 61.2%.

28. The composite membrane of claim 19, wherein the composite membrane has an ideal salt selectivity between NaCl to MgCl₂ greater than 1 to up to 40.

29. The composite membrane of claim 19, wherein the composite membrane has an ion selectivity between monovalent anion to divalent anion in a mixed salt feed greater than 1 to up to 1460.

30. The composite membrane of claim 19, wherein the composite membrane exhibits molecular weight cut-off from 287 g/mol to 390 g/mol.

31. The composite membrane of claim 19, wherein the upper polymer nanofilm layer has an elemental composition (atomic %) of: from 71.4% to 74.8% carbon, from 7.5% to 12.8% nitrogen, and from 12.4% to 21.1% oxygen, and wherein a polymer repeating unit of the upper polymer nanofilm layer is selected from piperazine and trimesoyl chloride.

32. A process for preparing a highly selective ultrathin polymer nanofilm composite membrane, the process comprising:
(a) preparing a polymer support membrane via phase inversion method on a nonwoven fabric;
(b) modifying the polymer support membrane as obtained in (a) to obtain a hydrophilic support membrane;
(c) separately dissolving 0.01 to 5.0 w/w % polyamine into an aqueous solvent to obtain a solution A;
(d) separately dissolving 0.001 to 0.5 w/w % polyfunctional acid halide into an organic solvent to obtain a solution B;
(e) adding 0.01 mM to 1M surface active reagent in the solution A obtained in (c);
(f) pouring the solution A obtained in (e) on a top of the hydrophilic support membrane of (b), followed by soaking for 10 seconds to 1 minute;
(g) discarding aqueous solution from the hydrophilic support membrane and removing the remaining aqueous solution with a rubber roller followed by air drying for 10 seconds to 1 minute;
(h) immediately contacting solution B as obtained in (d) to the hydrophilic support membrane of (g) for 5 seconds to 20 minutes for interfacial polymerization to obtain a nanofilm;
(i) removing excess organic solution, followed by removing unreacted polyfunctional acid halide remaining on the nanofilm, and drying the membrane at room temperature for 10 seconds to 30 seconds;
(j) annealing the membrane at 40° C. to 90° C. for 1 minute to 10 minutes to obtain the highly selective ultrathin polymer nanofilm composite membrane.

33. The process of claim 32, wherein the organic solvent in (d) is selected from the group consisting of acyclic alkanes and isoalkanes, monocyclic cycloalkanes, aromatic hydrocarbons, esters, and mixtures thereof.

34. The process of claim 32, wherein the polyamine in (c) is selected from the group consisting of piperazine (PIP), m-phenylenediamine (MPD), p-phenylenediamine (PPD), polyethyleneimine (PEI), 4-(aminomethyl)piperidine (AMP), 1,3-cyclohexane diamine (CDA13), 1,4-cyclohexane diamine (CDA14), 1,6-hexanediamine (HDA), and ethylene diamine (EDA).

35. The process of claim 32, wherein the polyfunctional acid halide in (d) is selected from the group consisting of terephthaloyl chloride (TPC), 1,3,5-benzenetricarbonyl trichloride, trimesoyl chloride (TMC), and combinations thereof.

36. The process of claim 32, wherein a freestanding isolated polymer nanofilm is formed at the interface when two reactive molecular solutions A and B as obtained in (e) are contacted to form a liquid-liquid interface and is further transferred onto a porous support to form a composite membrane.
